(19) United States
(12) Patent Application Publication
(10) Pub. No.: US 2026/0087065 A1
(43) Pub. Date: Mar. 26, 2026

(54) CLASSIFICATION AND FILTERING IN AN AUGMENTED SEMANTIC SEARCH SYSTEM

(71) Applicant: Tubi, Inc., San Francisco, CA (US)

(72) Inventors: John Trenkle, Albany, CA (US); Jaya Kawale, San Jose, CA (US); Blake Scott Bassett, Portland, OR (US); Bethany Marie Baker, Berkeley, CA (US); Claire Elise Dorman, Oakland, CA (US); Fenglin Yuan, New York, NY (US)

(73) Assignee: Tubi, Inc., San Francisco, CA (US)

(21) Appl. No.: 18/936,930

(22) Filed: Nov. 4, 2024

Related U.S. Application Data
(60) Provisional application No. 63/699,787, filed on Sep. 26, 2024.

(51) Int. Cl. G06F 16/435

(52) U.S. Cl. CPC G06F 16/435

(57) ABSTRACT

A system and method for augmented semantic search, including: a query execution service including functionality to receive a search request including a query string; a query classification service including functionality to execute a first large language model using a first prompt to generate a classification object representing classification of the query string in a structured classification format; a filter extraction service including functionality to execute a second large language model using a second prompt to generate a filter object including a set of filters inferred for the query string in the structured filter format; and a recaller service including functionality to: use the filter object to constrain search space of a vector store and execute a vector similarity operation on a query vector to generate a match set of embeddings; and provide a result set based on the match set of embeddings.

### CROSS-REFERENCE TO RELATED APPLICATIONS

This application claims the benefit of U.S. Provisional Patent Application Ser. No. 63/699,787, Attorney Docket tubi.00018.us.p.1, entitled “MEDIA PERSPECTIVES, CLASSIFICATION AND FILTERING, AND RE-RANKING AND OUTLIER DETECTION IN AN AUGMENTED SEMANTIC SEARCH SYSTEM”, filed Sep. 26, 2024, including inventor John Trenkle et al., the entire disclosure of which is incorporated by reference herein, in its entirety, for all purposes.

This application is related to, and herein incorporates by reference for all purposes, U.S. patent application Ser. No. ______, filed Sep. 26, 2024, entitled “MEDIA PERSPECTIVES IN AN AUGMENTED SEMANTIC SEARCH SYSTEM”, John Trenkle et al., Attorney Docket tubi.00018.us.n.1. U.S. patent application Ser. No. ______ claims the benefit of U.S. Provisional Patent Application No. 63/699,787, Attorney Docket tubi.00018.us.p.1, entitled “MEDIA PERSPECTIVES, CLASSIFICATION AND FILTERING, AND RE-RANKING AND OUTLIER DETECTION IN AN AUGMENTED SEMANTIC SEARCH SYSTEM”, filed Sep. 26, 2024, including inventor John Trenkle et al.

This application is related to, and herein incorporates by reference for all purposes, U.S. patent application Ser. No. ______, filed Sep. 26, 2024, entitled “RE-RANKING AND OUTLIER DETECTION IN AN AUGMENTED SEMANTIC SEARCH SYSTEM”, John Trenkle et al., Attorney Docket tubi.00020.us.n.1. U.S. patent application Ser. No. ______ claims the benefit of U.S. Provisional Patent Application No. 63/699,787 , Attorney Docket tubi.00018.us.p.1, entitled “MEDIA PERSPECTIVES, CLASSIFICATION AND FILTERING, AND RE-RANKING AND OUTLIER DETECTION IN AN AUGMENTED SEMANTIC SEARCH SYSTEM”, filed Sep. 26, 2024, including inventor John Trenkle et al.

### BACKGROUND

Digital media has transformed the landscape of content consumption over the past few decades. From the early days of broadcast television to the current era of streaming platforms, the sheer volume and diversity of available content have grown exponentially. This proliferation of media options has presented both opportunities and challenges for content providers and consumers alike.

Concurrently, the field of information retrieval has undergone significant advancements. Traditional keyword-based search methods, while effective for certain applications, have shown limitations in capturing the nuanced intent behind user queries, particularly in the context of media content discovery. The concept of semantic search emerged as a potential approach to enhance the relevance and accuracy of search results by attempting to understand the contextual meaning of search terms.

The intersection of digital media and advanced search technologies has been an area of ongoing research and development. Content recommendation systems have become increasingly sophisticated, aiming to suggest relevant media items based on various factors such as user preferences, viewing history, and content metadata. However, the complexity of human interests and the subjective nature of media consumption have continued to present challenges in achieving highly personalized and contextually relevant recommendations.

As the media landscape continues to evolve, so too does the need for more effective content discovery mechanisms. The vast libraries of digital content available today span numerous genres, formats, and cultural contexts, creating a potentially overwhelming array of choices for consumers. This abundance of options has led to increased interest in developing more intuitive and efficient ways for users to navigate and discover content that aligns with their specific interests and preferences.

### SUMMARY

In general, in one aspect, embodiments relate to systems and methods for using structured data representation of a set of media perspectives in semantic search. Each media item is ingested and analyzed by multiple components of the system to generate a variety of documents representing different media perspectives. The documents can then be utilized to perform semantic search, content discovery, and recommendation.

In general, in one aspect, embodiments relate to a system for augmented semantic search. The system can include: a computer processor; a query execution service including functionality to receive a search request including a query string from a client application; a query classification service including functionality to: generate a first prompt including the search request, a set of categories, descriptions of the set of categories, and definition of a structured classification format; and execute a first large language model using the first prompt to generate a classification object representing classification of the query string in the structured classification format; a filter extraction service executing on the computer processor and including functionality to: generate a second prompt including the search request, a set of filter criteria, and definition of a structured filter format; and execute a second large language model using the second prompt to generate a filter object including a set of filters inferred for the query string in the structured filter format; and a recaller service including functionality to: generate a query vector for the search request using the query string, the classification object, and the filter object; use the filter object to identify a constrained set of candidate embeddings of a vector store; execute a vector similarity operation on the query vector and the constrained set of candidate embeddings to generate a match set of embeddings; and provide, in response to the search request, a result set including identifiers of a matching set of media items referenced by the match set of embeddings.

In general, in one aspect, embodiments relate to a method for augmented semantic search. The method can include: receiving a search request including a query string from a client application; generating a first prompt including the search request, a set of categories, descriptions of the set of categories, and definition of a structured classification format; executing, by a computer processor, a first large language model using the first prompt to generate a classification object representing classification of the query string in the structured classification format; generating a second prompt including the search request, a set of filter criteria, and definition of a structured filter format; executing a second large language model using the second prompt to generate a filter object including a set of filters inferred for the query string in the structured filter format; generating a query vector for the search request using the query string, the classification object, and the filter object; using the filter object to identify a constrained set of candidate embeddings of a vector store; executing a vector similarity operation on the query vector and the constrained set of candidate embeddings to generate a match set of embeddings; and providing, in response to the search request, a result set including identifiers of a matching set of media items referenced by the match set of embeddings.

In general, in one aspect, embodiments relate to a non-transitory computer-readable storage medium having instructions for augmented semantic search. The instructions are configured to execute on at least one computer processor to enable the computer processor to: receive a search request including a query string from a client application; generate a first prompt including the search request, a set of categories, descriptions of the set of categories, and definition of a structured classification format; execute a first large language model using the first prompt to generate a classification object representing classification of the query string in the structured classification format; generate a second prompt including the search request, a set of filter criteria, and definition of a structured filter format; execute a second large language model using the second prompt to generate a filter object including a set of filters inferred for the query string in the structured filter format; generate a query vector for the search request using the query string, the classification object, and the filter object; use the filter object to identify a constrained set of candidate embeddings of a vector store; execute a vector similarity operation on the query vector and the constrained set of candidate embeddings to generate a match set of embeddings; and provide, in response to the search request, a result set including identifiers of a matching set of media items referenced by the match set of embeddings.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIGS. 1A-1E show schematic diagrams of a media platform, in accordance with one or more embodiments.

FIG. 2 shows a diagram depicting the relationship between autodata, metadata, and teledata, in accordance with one or more embodiments.

FIG. 3 shows a diagram depicting a variety of media perspectives, in accordance with one or more embodiments.

FIG. 4 shows a diagram depicting the relationship between metadata and autodata, in accordance with one or more embodiments.

FIG. 5A shows a diagram depicting a summary hierarchy media perspective, in accordance with one or more embodiments.

FIG. 5B shows a table including summary hierarchy examples, in accordance with one or more embodiments.

FIG. 6 shows a table including guardrails media perspective examples, in accordance with one or more embodiments.

FIGS. 7A-7D show tables including multi-dimensional feature examples, in accordance with one or more embodiments.

FIG. 8 shows a table including brand safety media perspective examples, in accordance with one or more embodiments.

FIG. 9 shows a table including microgenre media perspective examples, in accordance with one or more embodiments.

FIG. 10 shows a table including vibes media perspective examples, in accordance with one or more embodiments.

FIG. 11 shows a table including genrative media perspective examples, in accordance with one or more embodiments.

FIG. 12 shows a table including action media perspective examples, in accordance with one or more embodiments.

FIGS. 13A and 13B show tables depicting example data derived from rave reviews media perspectives, in accordance with one or more embodiments.

FIGS. 14A-14B show schematic diagrams of semantic search architectures, in accordance with one or more embodiments.

FIG. 15 shows a flowchart depicting a semantic search process in accordance with one or more embodiments.

FIG. 16 shows a flowchart depicting a semantic search multi-classification process in accordance with one or more embodiments.

FIG. 17 shows a flowchart depicting a process for structured data representation of a set of media perspectives, in accordance with one or more embodiments.

FIGS. 18A-18B show a flowchart depicting a process for augmented semantic search, in accordance with one or more embodiments.

FIGS. 19A-19B show a flowchart depicting a process for re-ranking in an augmented semantic search, in accordance with one or more embodiments.

FIGS. 20 and 21 show a computing system and network architecture in accordance with one or more embodiments.

### DETAILED DESCRIPTION

A portion of the disclosure of this patent document may contain material that is subject to copyright protection. The copyright owner has no objection to the facsimile reproduction by anyone of the patent document or the patent disclosure, as it may appear in the Patent and Trademark Office patent file or records, but otherwise reserves all copyrights whatsoever.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

In general, embodiments of the present disclosure provide methods and systems for generating and utilizing documents and embeddings representing a variety of media perspectives. One or more media items is ingested for analysis, and a variety of different structured data representations of different media perspectives is generated for each media item. These structured data representation documents are then analyzed and utilized to generate embeddings representing the documents in a dense, distributed vector space.

In general, embodiments of the present disclosure provide methods and systems for augmented semantic search. A search query for media-related content is obtained from a client. One or more large language models are utilized for performing query classification and content filtering prior to generating an embedding representing the query. The generated content filter(s) may be utilized to constrain a search area of a vector store for the request, while classification data may be utilized to bifurcate or otherwise split the request into multiple concurrent requests addressing different classifiers. A vector similarity operation is executed to identify one or more candidate results. Subsequently, a large language model based re-ranking process may be performed to detect outliers and/or to re-rank the results in a final result set provided in response to the request.

The systems and methods outlined in this disclosure encompass functionality for semantic search across diverse types of media and content. While many of the described systems and processes use video as an illustrative example, it is important to emphasize that these approaches are applicable to a wide array of data types and formats. This includes, but is not limited to, books, podcasts, music albums, academic papers, news articles, blog posts, social media content, educational courses, and interactive digital experiences. The semantic search capabilities described herein can be effectively applied to any form of content that is disseminated to audiences, whether it be for entertainment, information, education, or other purposes.

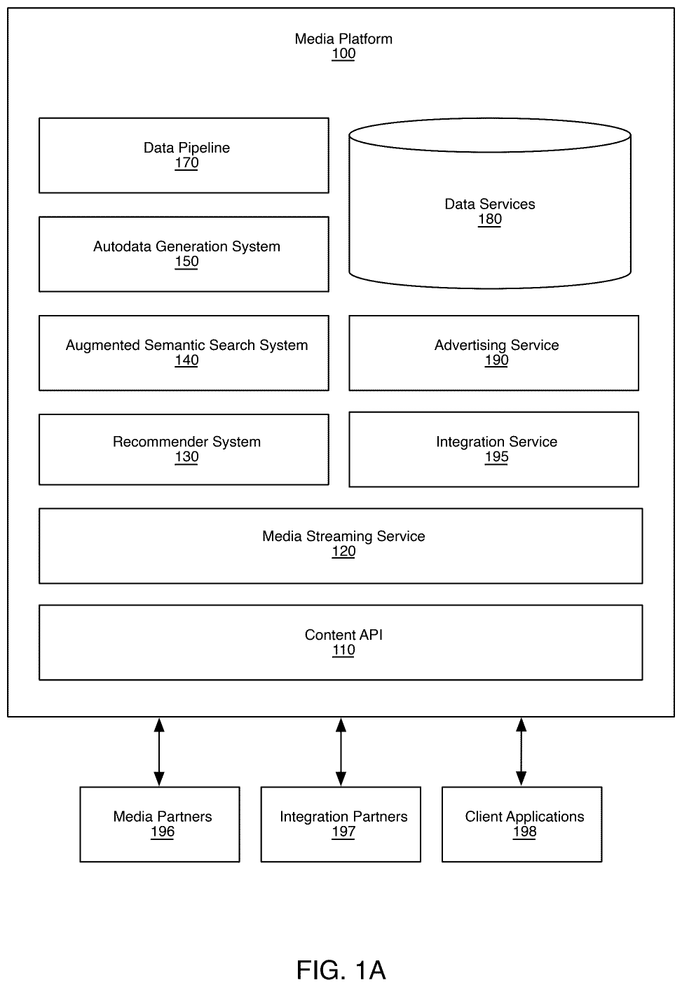

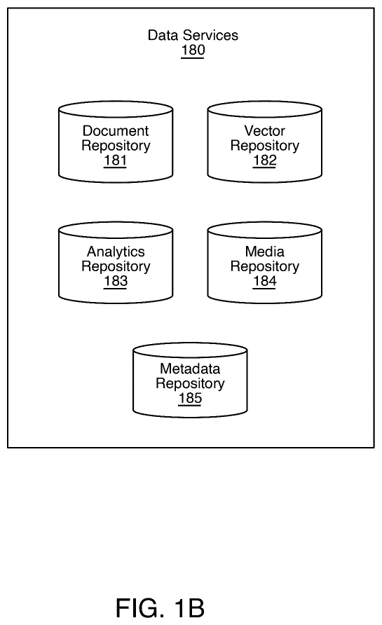

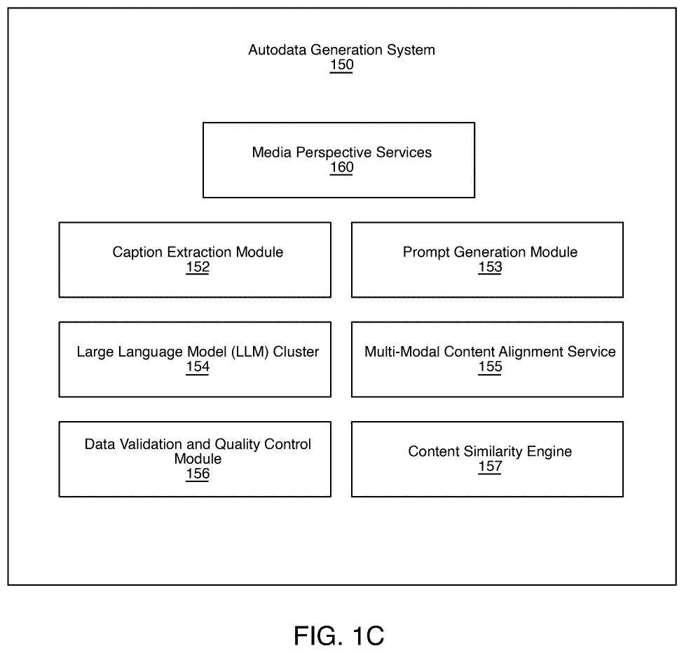

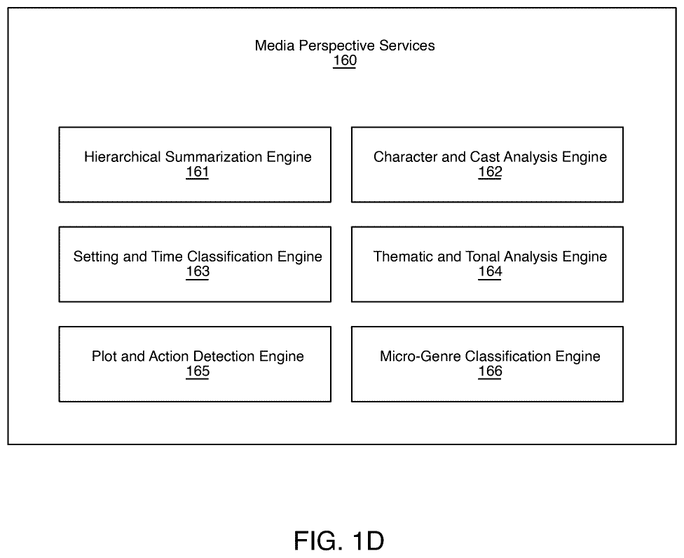

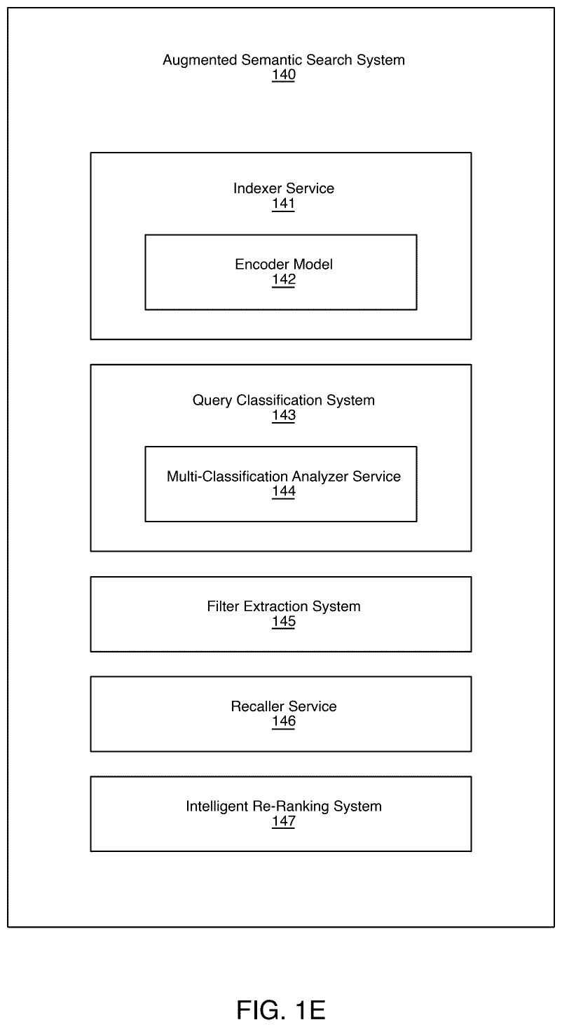

FIG. 1A shows a media platform 100 in communication with media partners 196, integration partners 197, and client applications 198, in accordance with one or more embodiments. As shown in FIG. 1A, the media platform 100 has multiple components including a data pipeline 170, an autodata generation system 150, an augmented semantic search system 140, a recommender system 130, a media streaming service 120, a content application programming interface (API) 110, an advertising service 190, an integration service 195, and a variety of data services 180. Various components of the media platform 100 can be located on the same device (e.g., a server, an elastic compute device orchestrated by a cloud service provider, a mainframe, desktop personal computer (PC), laptop, mobile device, kiosk, cable box, and any other device) or can be located on separate devices connected by a network (e.g., a virtual private cloud (VPC), a local area network (LAN), the Internet, etc.). Those skilled in the art will appreciate that there can be more than one of each separate component running on a device, as well as any combination of these components within a given embodiment.

In one or more embodiments, the media platform 100 is a platform for facilitating ingestion, analysis, and search of media-related content. For example, the media platform 100 may store or be operatively connected to services storing millions of media items such as movies, user-generated videos, music, audio books, and any other type of media content. The media content may be provided for viewing by end users of a video or audio streaming service (e.g., media streaming service 120), for example. Media services provided by the media platform 100 can include, but are not limited to, generation and vectorization of media streaming perspectives, semantic search, and other functionality disclosed herein.

In one or more embodiments of the invention, the media platform 100 is a technology platform including multiple software services executing on different novel combinations of commodity and/or specialized hardware devices. The components of the media platform 100, in the non-limiting example of FIG. 1A, are software services implemented as containerized applications executing in a cloud environment. The autodata generation system 150, augmented semantic search 140, recommender system 130, and related components can be implemented using specialized hardware to enable parallelized analysis and performance. Other architectures can be utilized in accordance with the described embodiments.

In one or more embodiments of the invention, autodata generation system 150, augmented semantic search 140, recommender system 130, and the content application programming interface (API) 110 are software services or collections of software services configured to communicate both internally and externally of the media platform 100, to implement one or more of the functionalities described herein. The systems described in the present disclosure may depict communication and the exchange of information between components using directional and bidirectional lines. Neither is intended to convey exclusive directionality (or lack thereof), and in some cases components are configured to communicate despite having no such depiction in the corresponding figures. Thus, the depiction of these components is intended to be exemplary and non-limiting.

In one embodiment of the invention, the autodata generation system 150 is a component of the data pipeline 170. The arrangement of the components and their corresponding architectural design are depicted as being distinct and separate for illustrative purposes only. Many of these components can be implemented within the same binary executable, containerized application, virtual machine, pod, or container orchestration cluster. Performance, cost, and application constraints can dictate modifications to the architecture without compromising function of the depicted systems and processes.

Although the components of the media platform 100 are depicted as being directly communicatively coupled to one another, this is not necessarily the case. For example, one or more of the components of the media platform 100 may be communicatively coupled via a distributed computing system, a cloud computing system, or a networked computer system communicating via the Internet.

### Media Perspectives

For purposes of this disclosure, in one or more embodiments, the term “metadata” may refer to information about a media item that is typically provided by external sources or production entities, such as title, release year, genre, or other basic descriptive information. This metadata may be generally static and limited in scope. In contrast, the term “autodata” may refer to a richer, more dynamic set of structured data representations derived from the content of the media item itself. Autodata may encompass various media perspectives, each potentially represented by a separate document or data structure. These media perspectives may include, but are not limited to, summary hierarchies, microgenres, vibes, tropes, themes, character profiles, setting details, and action characterizations. Autodata may be generated through analysis of the media item's content, including dialog, video, and audio components, often utilizing advanced technologies such as large language models. It is understood that a single media item may be associated with multiple autodata documents, each representing a distinct media perspective or aspect of the content. The specific components and structure of autodata may vary depending on the nature of the media item and the depth of analysis performed. This definition of autodata is intended to be broad and may encompass additional or alternative elements as technology and analysis methods evolve.

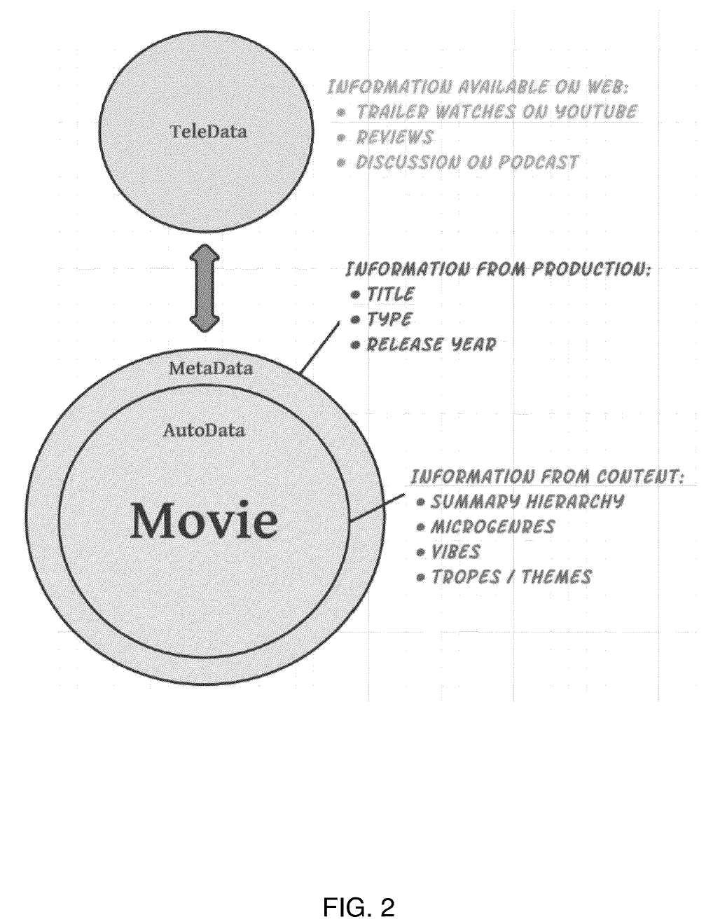

FIG. 2 illustrates the relationship between a movie and its associated data types: teledata, metadata, and autodata. At the core is the movie itself, surrounded by concentric circles representing different layers of information. The innermost circle, autodata, is depicted as being derived directly from the movie's content and includes elements such as summary hierarchy, microgenres, vibes, and tropes/themes. This aligns with the description of autodata, in one or more embodiments, as content-derived, structured data representations. The middle circle represents metadata, which includes information from production sources such as title, type, and release year. This corresponds to the description of metadata as, in or more embodiments, basic, externally provided information. The outermost circle, teledata, represents information available on the web, including trailer watches on YouTube, reviews, and podcast discussions. This additional layer expands on the concept of metadata to include publicly available, third-party generated information. The bi-directional arrow between teledata and metadata suggests a potential interplay or exchange of information between these two data types. This comprehensive visualization underscores the multi-faceted nature of data associated with media items, highlighting the distinction between content-derived autodata and various forms of externally sourced information.

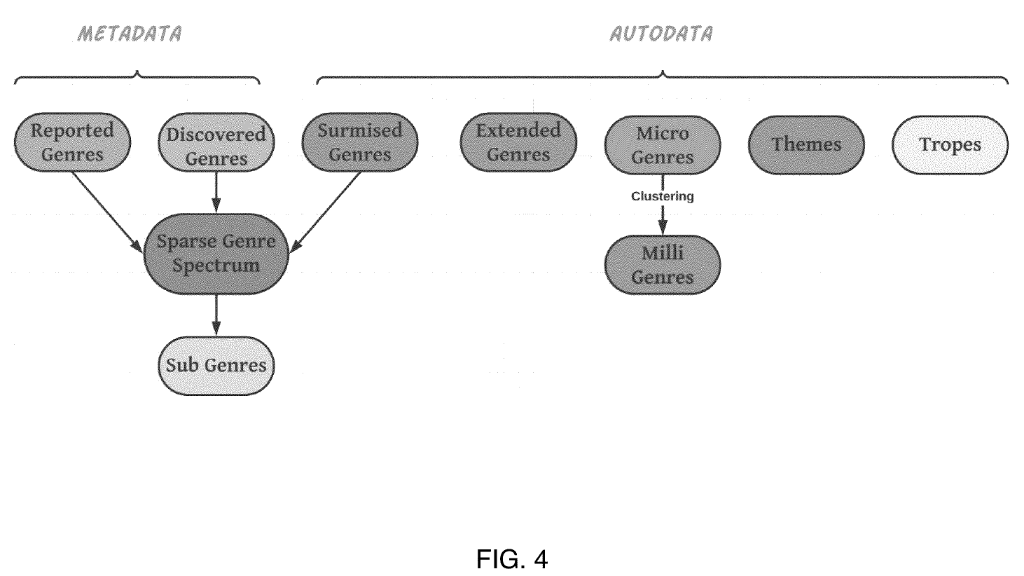

FIG. 4 illustrates a conceptual diagram depicting the relationship between metadata and autodata in the context of genre classification for media content. The diagram is divided into metadata and autodata sections, highlighting the progression from externally provided genre information to more refined, content-derived classifications. In the metadata section, reported, discovered, and surmised genres converge to form a sparse genre spectrum, which further leads to sub-genres. This represents the traditional, broad categorization typically associated with metadata. In contrast, the autodata section showcases extended genres, micro genres, themes, and tropes, demonstrating the system's capability to generate increasingly granular and nuanced content categorizations. The presence of milli genres, derived through clustering of micro genres, further emphasizes the depth of analysis possible with autodata. This figure effectively conveys the distinction between metadata's limited, externally-defined classifications and autodata's rich, content-derived insights, illustrating the enhanced understanding of media content enabled by the autodata generation system 150.

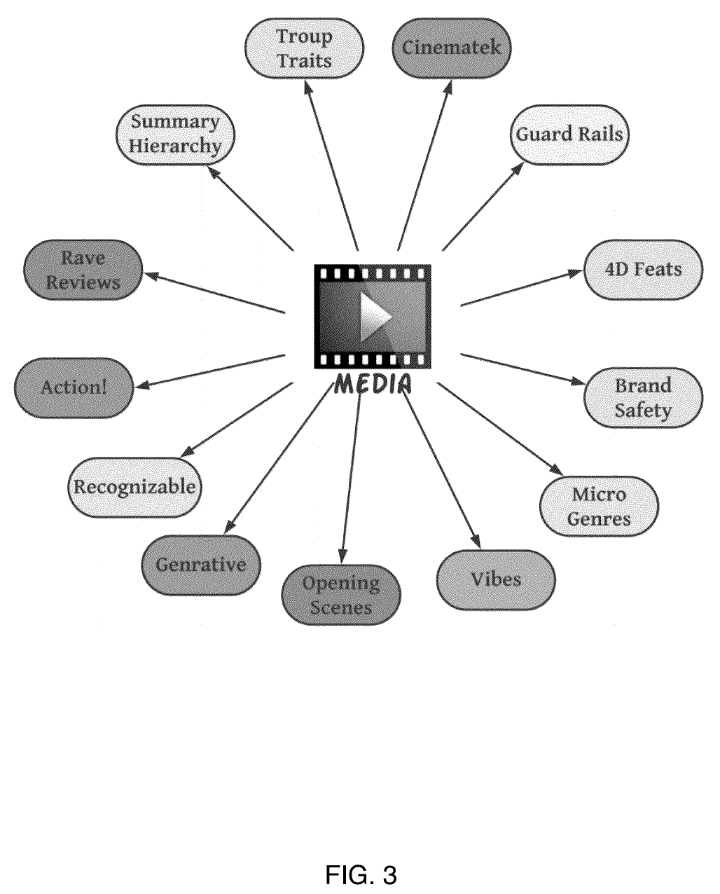

FIG. 3 illustrates a variety of media perspectives, represented as autodata types, associated with a central media item symbolized by a video play icon. Surrounding this central icon are multiple nodes, each depicting a distinct media perspective that can be extracted or derived from the source content. These perspectives include summary hierarchy, offering multi-level summaries for all titles, independent of perceived quality; guardrails, providing assessments of protected content and cultural/ethnic cinema; troup traits, detailing character profiles including demographics and occupations; brand safety, offering information about topics such as sex, violence, drugs, and weapons; 4D feats, providing detailed information about the spatial and temporal settings of the story; micro genres, identifying granular subcategories that transcend typical genre labels; vibes, capturing the general mood, feeling, atmosphere, ambience, or emotional tone; genrative, enhancing genres with tropes and thematic information about the plots; and action, characterizing content by the type, amount, and intensity of action. Each of these media perspectives is directly connected to the central media item, illustrating that they are all derived from or closely related to the content itself. This visualization emphasizes the multi-dimensional nature of autodata, showcasing how a single media item can generate a rich array of structured data representations, each offering a unique perspective or insight into the content. These diverse media perspectives collectively provide a comprehensive understanding of the media item, enabling more sophisticated content analysis, discovery, and recommendation systems.

### Data Services

FIG. 1B shows data services 180, in accordance with one or more embodiments. As shown in FIG. 1B, data services 180 has multiple components including a document repository 181, a vector repository 182, an analytics repository 183, a media repository 184, and a metadata repository 185. Various components of the data services 180 can be located on the same device (e.g., a server, an elastic compute device orchestrated by a cloud service provider, a mainframe, desktop personal computer (PC), laptop, mobile device, kiosk, cable box, and any other device) or can be located on separate devices connected by a network (e.g., a virtual private cloud (VPC), a local area network (LAN), the Internet, etc.). Those skilled in the art will appreciate that there can be more than one of each separate component running on a device, as well as any combination of these components within a given embodiment.

In one or more embodiments of the invention, each data service (181, 182, 183, 184, 185) of the data services 180 includes both business logic and/or storage functionality. For purposes of this disclosure, the terms “repository” and “store” may refer to a storage system, database, database management system (DBMS), or other storage related technology, including persistent or non-persistent data stores, in accordance with various embodiments of the invention.

In one or more embodiments of the invention, each repository includes both persistent and non-persistent storage systems, as well as application logic configured to enable performant storage, retrieval, and transformation of data to enable the functionality described herein. Non-persistent storage such as Redis, Memcached, and an in-memory data store can be utilized to cache data in order to increase performance of frequently accessed data and reduce the latency of requests.

In one or more embodiments of the invention, the media repository 184 includes functionality to store media items. Media items can include both source media items, advertising media items, and derived media items such as previews or clips, and can comprise media types and file formats of various types. Examples of media items can include, but are not limited to, movies, television shows, series, episodes, video episodes, podcasts, music, audiobooks, documentaries, concerts, live event recordings, news broadcasts, educational content, instructional videos, sports events, video blogs (vlogs), reality shows, animations, short films, trailers, behind-the-scenes footage, interviews, and user-generated content. Each of these media items can be stored, categorized, and retrieved in multiple formats such as MP4, AVI, WMV, MOV, MP3, WAV, FLAC, and others.

In one or more embodiments of the invention, the document repository 181 includes functionality to store structured data representations of media perspectives, referred to as autodata documents. These documents may contain various types of content-derived information, such as summary hierarchies, character profiles, thematic analyses, and action characterizations. The repository may support storage and retrieval of multiple autodata documents for each media item, each document potentially representing a distinct media perspective. The autodata documents may be stored in formats such as JSON, XML, or other structured data formats that facilitate efficient querying and analysis. The document repository 181 may also include version control capabilities to track changes and updates to autodata documents over time.

In one or more embodiments of the invention, the vector repository 182 includes functionality to store dense, distributed vector representations of media items, autodata documents, and query embeddings. These vector embeddings may be generated using various encoder models and may represent the semantic content of media items, autodata perspectives, or user queries in a high-dimensional space. The repository may support efficient similarity search operations, enabling rapid retrieval of relevant content based on vector comparisons. It may also store multiple vector representations for each media item or autodata document, potentially corresponding to different aspects or perspectives of the content. The vector repository 182 may be optimized for high-performance read and write operations to support real-time search and recommendation functionalities.

In accordance with one or more embodiments of the invention, metadata repository 185 includes functionality to catalog, store, and facilitate access to a range of metadata. For example, the repository 185 may be configured to store JSON-formatted metadata obtained from external data sources or generated as part of the ingestion processes of the data pipeline 170. The metadata may encompass a spectrum of media attributes including, but not limited to, title, genre, duration, language, production cast and crew details, and content ratings. For purposes of this disclosure, in one or more embodiments of the invention and unless expressly stated otherwise, the term metadata may include teledata and other externally generated data relating to one or more content items.

In one or more embodiments of the invention, the analytics repository 183 includes functionality to store analytics data relating to one or more media items. Media items can include encoded media files, media previews, media clips, and media-related advertising content. Examples of analytics data can include, but are not limited to, user engagement data relating to a media item, feedback regarding placement of an advertisement, media clip, or media preview, usage data and performance data relating to media items, and feedback utilized as online training data in the training and retraining of one or more machine learning models.

### Media Perspectives Generation

FIG. 1C shows an autodata generation system 150 in accordance with one or more embodiments. As shown in FIG. 1C, the autodata generation system 150 has multiple components including a media perspective service 160, a caption extraction module 152, a prompt generation module 153, a large language model (LLM) cluster 154, a multi-modal content alignment service 155, a data validation and quality control module 156, and a content similarity engine 157. Various components of the autodata generation system 150 can be located on the same device (e.g., a server, an elastic compute device orchestrated by a cloud service provider, a mainframe, desktop personal computer (PC), laptop, mobile device, kiosk, cable box, and any other device) or can be located on separate devices connected by a network (e.g., a virtual private cloud (VPC), a local area network (LAN), the Internet, etc.). Those skilled in the art will appreciate that there can be more than one of each separate component running on a device, as well as any combination of these components within a given embodiment.

In one or more embodiments of the invention, the autodata generation system 150 incorporates a caption extraction module 152. This module is configured to identify a set of caption data for various media items stored within the media repository 184. Specifically, the caption extraction module 152 may utilize optical character recognition (OCR) techniques to extract captions from video frames. Alternatively, it can parse subtitle files associated with the media items. For instance, when processing a film, this module can extract dialogue from embedded subtitles or directly from on-screen text in the video, thus collecting data pivotal for further content analysis.

In one or more embodiments, the autodata generation system 150 includes a prompt generation module 153. The module 153 includes functionality to generate a specific prompt for each media item, using the extracted caption data. The prompt defines a structured data representation of a media perspective. For example, in the case of a movie stored in the media repository 184, the prompt generation module 153 might generate a prompt that instructs: “Analyze the following movie captions and generate a structured summary including the main plot points, key characters, and overall theme. Format the output as a JSON object.” This setup prepares the data for detailed analysis and representation in a structured format. The prompt generation module 153 may be configured to work in conjunction with various media perspective services 160 to generate autodata documents representing a variety of different media perspectives.

In one or more embodiments, the autodata generation system 150 features a large language model (LLM) cluster 154. This cluster is configured to process the prompts generated by the prompt generation module 153. It executes tasks to produce a structured data representation of the media perspective for each item. The LLM cluster 154 may employ multiple language models operating in parallel, each tasked with analyzing different aspects of the prompt. The results from these models are then aggregated to form a comprehensive structured data output, effectively capturing varied media perspectives.

In one or more embodiments, the autodata generation system 150 further includes a multi-modal content alignment service 155. This service is tasked with synchronizing extracted data across different media sources, such as text, audio, and video. The content alignment service 155 creates a unified temporal map of the content, which supports a more holistic understanding and analysis of the media item. For instance, this service can align audio descriptions with text captions and visual elements from a scene, ensuring that all data points are temporally and contextually synchronized, providing a deeper insight into the multimedia content.

In one or more embodiments of the invention, the multi-modal content alignment service 155 includes functionality to align transcripts with audio tracks of a media item. In one or more embodiments, the service 155 utilizes speech recognition technology to generate timestamps for each spoken word in the audio tracks. The service 155 then aligns these timestamps with the text in the transcripts. This alignment process ensures that each segment of spoken audio corresponds accurately to its textual representation.

In one or more embodiments of the invention, the multi-modal content alignment service 155 includes functionality to process video data by identifying key frames and scenes. The service 155 may employ computer vision techniques for this identification process. The service 155 is configured to match descriptions of scenes provided in the transcripts with these identified video frames. This matching process may involve analyzing various visual elements, which can include, but are not limited to: setting, character presence, actions, lighting, camera angles, and object recognition. By performing this analysis, the service 155 ensures that each scene description accurately reflects the visual content of the media item.

In one or more embodiments of the invention, the multi-modal content alignment service 155, includes functionality to perform speaker identification. The service 155 may analyze the audio to identify different speakers and correlate this information with dialogue lines in the transcripts. This correlation process can involve various techniques, such as voice pattern recognition, pitch analysis, or machine learning algorithms trained on speaker identification tasks. By attributing each piece of dialogue to the correct speaker in both audio and video formats, the service 155 provides a more comprehensive understanding of the media item.

In one or more embodiments of the invention, after aligning the various components, the multi-modal content alignment service 155 includes functionality to construct a unified temporal map. This map links a variety of synchronized elements, creating a comprehensive structured data object that encapsulates all aligned data points. The unified representation may include, but is not limited to: timestamped transcripts, audio segments, video frames, scene descriptions, speaker identifications, and any other relevant metadata. This unified representation provides a multi-dimensional view of the media item that includes textual, auditory, and visual data in a synchronized format, enabling detailed content analysis and supporting various downstream applications.

The multi-modal content alignment service 155, in one or more embodiments of the invention, includes functionality to store cross-references between different modalities in the media repository 184. These cross-references can take various forms, such as pointers, indices, or relational database structures, depending on the specific implementation of the system. This comprehensive alignment and cross-referencing process supports a wide range of applications within the media platform 100, which may include, but are not limited to: content summarization, thematic analysis, character tracking, plot development analysis, and enhanced semantic search functionalities.

In one or more embodiments of the invention, the autodata generation system 150 further includes functionality for automated autodata generation. The system is configured to extract key information from content to populate structured autodata fields within the structured data representations. The media perspective services 160 may include multiple specialized engines, such as the hierarchical summarization engine 161, character and cast analysis engine 162, setting and time classification engine 163, thematic and tonal analysis engine 164, plot and action detection engine 165, and micro-genre classification engine 166. Each of these engines may be configured to define specific prompts for the prompt generation module 153, resulting in the generation of various types of metadata automatically. For example, the character and cast analysis engine 162 may generate a prompt like: “Analyze the dialogue and actions of characters in the provided captions. For each main character, provide a JSON object with fields for name, age range, personality traits, and key relationships.” The setting and time classification engine 163 might create a prompt such as: “Based on the captions, determine the primary settings of the story and the time period in which it takes place. Provide this information in a structured format, distinguishing between the story's setting and its production era.” The resulting structured data representations are stored in the document repository 181, with multiple different representations of different media perspectives for each media item. As an example, a single movie in the media repository 184 might have corresponding documents in the document repository 181 for its plot summary, character analysis, setting classification, and thematic analysis, each stored as a separate JSON or XML structure.

In one or more embodiments of the invention, the augmented semantic search system employs a combination of offline and online processing to optimize performance and ensure real-time responsiveness. The offline processing primarily involves autodata generation and embedding. During this phase, the system processes media items, extracting relevant information and generating structured data representations. These representations are then embedded into dense vector representations using sophisticated encoder models. The resulting embeddings are stored in the vector store, creating a rich, pre-computed database of searchable content. This offline processing allows for computationally intensive tasks to be performed in advance, reducing the load on the system during real-time operations. In contrast, the online processing focuses on real-time query processing and search execution. When a user submits a search request, the system rapidly classifies the query, extracts relevant filters, and generates a query embedding. These operations leverage pre-trained machine learning models and large language models to ensure quick and accurate processing. The system then performs vector similarity operations on the pre-computed embeddings in the vector store, constrained by the extracted filters, to identify the most relevant results. This combination of offline preparation and online execution enables the system to handle complex semantic searches with high efficiency and low latency, providing users with fast, accurate, and contextually relevant results.

### Summary Hierarchy Media Perspectives

One media perspective supported by the autodata generation system 150 is hierarchical summarization. In one or more embodiments of the invention, the media platform 100 integrates the hierarchical summarization engine 161 to construct hierarchical summaries of one or more media items.

The hierarchical summarization engine 161 generates summaries at multiple levels of detail, supporting diverse applications. Specifically, this includes the generation of a “Jumbo” summary, which offers a comprehensive six-paragraph narrative capturing detailed story progressions; a “Condensed” summary, focusing on crucial plot elements within three paragraphs; a “Capsule” summary that distills the narrative into three (or any number or range of) sentences; and a “Particle” summary, a succinct expression of the most vital points in a predefined number of words (e.g., twenty words). Each summary type can be defined based on a threshold character/content limit. The intent behind this gradation is to supply scalable insights into media content that support diverse functionalities including content recommendation, quick searches, educational uses, and in-depth content analysis. This tiered approach enables a deep and scalable understanding of content, which facilitates various use cases such as enhanced search capabilities and personalized content recommendations.

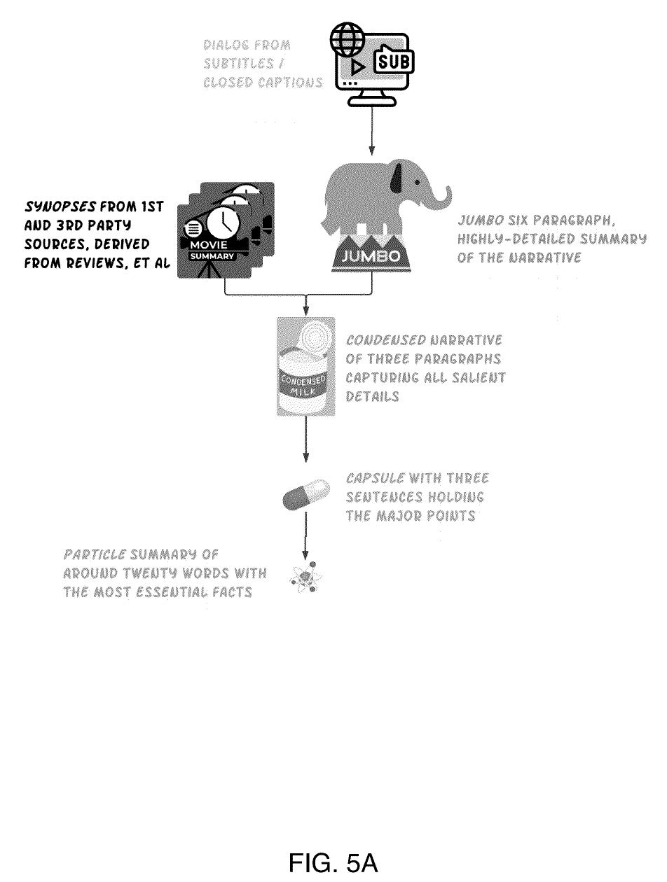

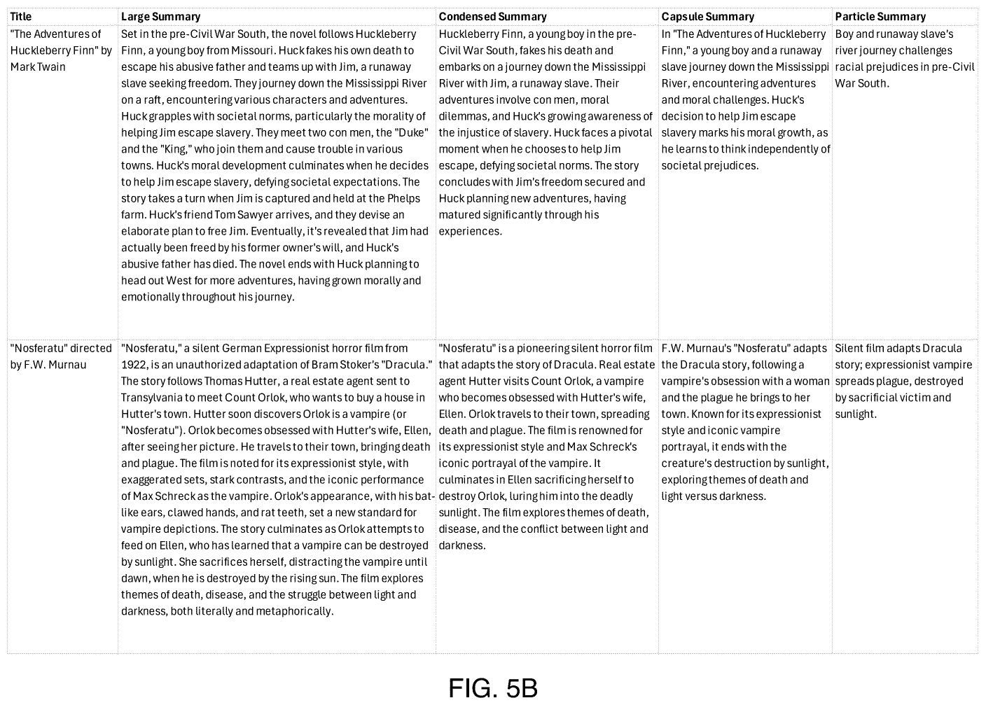

FIG. 5A illustrates the interconnection and flow between different levels of summary within the hierarchy. The diagram begins with the extraction of dialogue from subtitles and closed captions, which forms the base data layer feeding into a variety of media perspective types. The graphical representations in the figure, ranging from an elephant symbolizing the comprehensive coverage of the Jumbo summary to a capsule denoting the concise nature of the capsule summary, visually underscore the degree of content distillation at each level.

FIG. 5B provides examples of documents for each summary type applied to fictional media titles. The Jumbo summary of “The Adventures of Huck Finn” offers an extensive narrative with detailed character motivations and plot developments. The condensed summary reduces the narrative into fewer paragraphs focusing on essential plot points and character interactions. The capsule summary encapsulates the overarching narrative and thematic elements in just three sentences, facilitating quick comprehension. Finally, the particle summary distills the narrative to its most essential facts, tailored for rapid consumption or use as metadata for indexing purposes.

In one or more embodiments of the invention, the hierarchical summarization engine 161 includes functionality to provide configurable summary depth and focus areas. This feature allows users or system administrators to dynamically adjust the level of detail and emphasis within each summary type based on specific requirements or preferences. The engine 161 may include a set of parameters that can be modified to control the depth of information included in each summary level. For example, users might specify a desire for more character development details in the Jumbo summary, or a focus on thematic elements in the Condensed summary. The focus areas can be customized to highlight particular aspects of the media item, such as plot twists, character arcs, or setting descriptions. In one or more embodiments, the engine 161 utilizes natural language processing techniques to identify and extract information relevant to the specified focus areas. This configurability enhances the versatility of the summarization system, enabling it to cater to diverse use cases ranging from general audience consumption to specialized analytical needs. The engine 161 may also include functionality to dynamically adjust the word or character count thresholds for each summary type, allowing for flexible adaptation to different content lengths and complexities across various media items.

### Guardrails Media Perspectives

Another media perspective supported by the autodata generation system 150 is guardrails. The guardrails media perspective is designed to measure, track, and moderate sensitive information regarding diverse storytelling elements of the media items.

In one or more embodiments of the invention, the guardrails documents track and manage content that is sensitive due to cultural, ethical, regulatory, and a variety of other considerations. This includes content directed at specific demographics such as gender, protected groups, children or seniors, as well as media items categorized under ethnic cinema, holiday-themed content, or anime. These guardrails are implemented to solidify the platform's understanding of titles, aiding in the accurate population of content containers while avoiding potential misclassifications that could lead to cultural insensitivity or inappropriate content targeting.

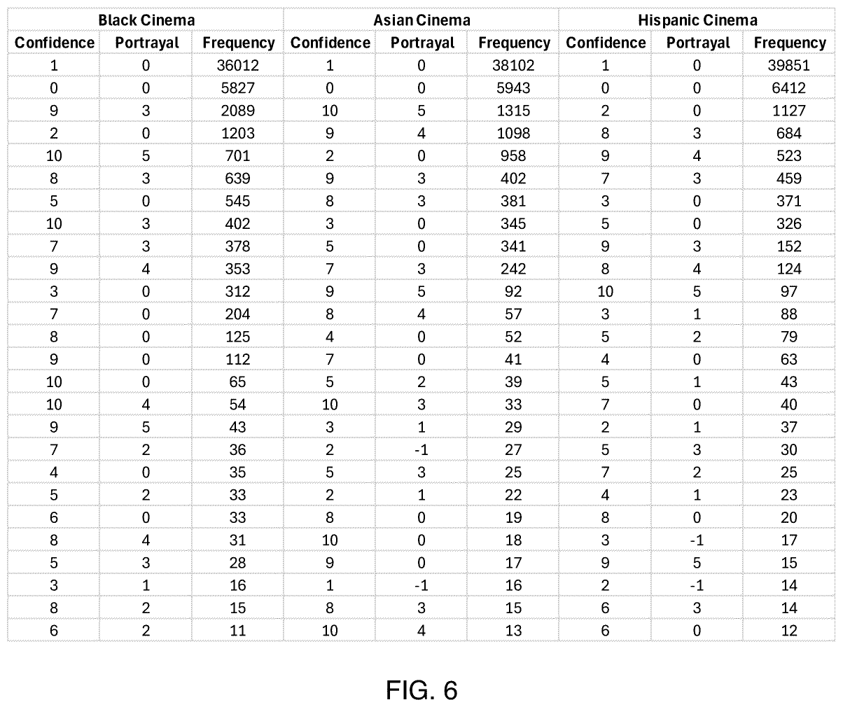

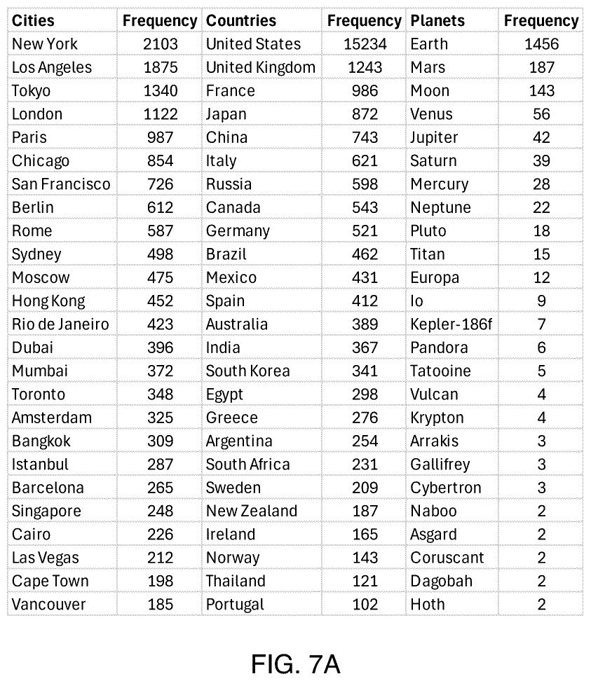

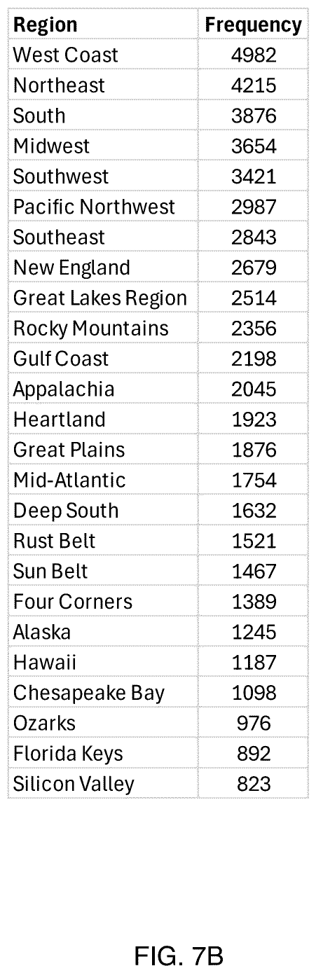

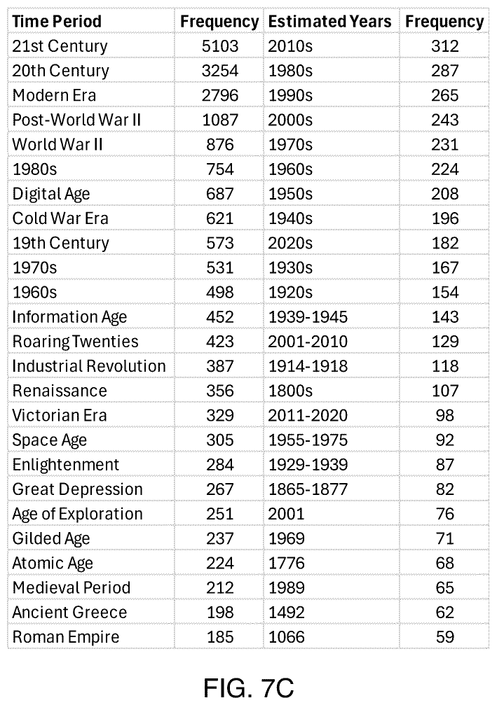

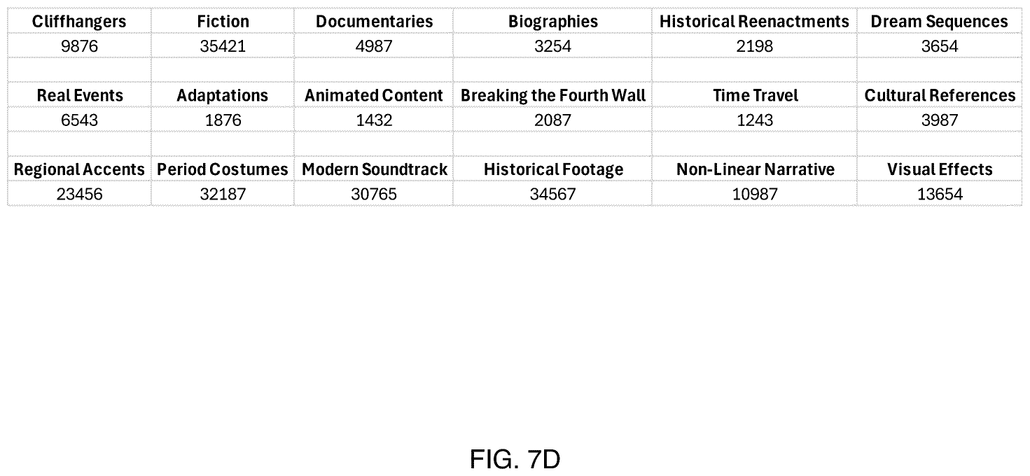

FIG. 6 is an example of guardrails identified within a corpus of media content, showcasing a tabular representation of data derived from guardrail documents in the document repository 181. The table includes confidence levels, portrayals, and frequencies across different cinema categories like Black Cinema, Asian Cinema, and Hispanic Cinema. Confidence metrics reflect the system's certainty in classifying and handling the content appropriately, portrayal indicates whether the media/role conveys a positive (e.g., +1) or negative (e.g., −1) portrayal of the ethnic category, and frequency is the number of times an entity with the corresponding confidence and portrayal for that ethnicity is represented in the media catalog. In one or more embodiments of the invention, portrayal is captured as a value within a fixed numeric range representing the spectrum of positive to negative sentiment (e.g., from −5 to +5). In this scale, −5 indicates a strongly negative portrayal, 0 represents a neutral portrayal, and +5 signifies a strongly positive portrayal.

Moreover, guardrails documents support the platform's “Fan of” initiatives, which aim to engage users by connecting them with content that resonates with their cultural background or personal interests. By leveraging accurate and sensitive portrayal metrics, the platform can create targeted content containers that appeal to specific user segments, enhancing content discoverability and personalization.

### Character and Cast Features Media Perspectives

In one or more embodiments of the invention, the character and cast analysis engine 162 is configured to perform automated extraction of character traits, relationships, and demographics, as well as conduct ensemble analysis for entire casts or character groups. The engine 162 includes functionality to analyze dialogue, actions, and descriptions within the media item to identify and categorize individual character attributes. These attributes may include, but are not limited to: personality traits, physical characteristics, occupations, backstories, and character arcs throughout the narrative.

In one or more embodiments of the invention, the character and cast analysis engine 162 utilizes natural language processing and machine learning techniques to infer relationships between characters. This may involve analyzing dialogue patterns, scene co-occurrences, and explicit narrative statements to determine familial, romantic, professional, or antagonistic connections between characters. The engine 162 may also extract demographic information such as age, gender, ethnicity, and socioeconomic status, when such information is available or can be reasonably inferred from the content.

In one or more embodiments of the invention, the character and cast analysis engine 162 includes functionality to perform ensemble analysis on entire casts or character groups. This analysis may involve identifying group dynamics, power structures, and collective character development throughout the narrative. The engine 162 may generate aggregate statistics and insights about the cast as a whole, such as diversity metrics, character type distributions, or the evolution of group relationships over the course of the story.

In one or more embodiments of the invention, the character and cast analysis engine 162 generates structured data representations that enable diverse query types and applications. These structured representations may include fields for character archetypes, professions, relationship dynamics, and demographic information. For instance, the engine 162 may populate a “character_archetype” field with values such as “strong female lead” or “complex anti-hero,” allowing for precise filtering of media items based on these attributes. The engine 162 may also include a “character_profession” field, facilitating searches for media content featuring specific occupations like “lawyer,” “doctor,” or “teacher.” Relationship dynamics may be captured in fields such as “primary_relationship” or “character_conflicts,” enabling queries for media items with particular interpersonal themes. Demographic representations can be stored in fields like “character_ethnicity,” “character_age_range,” or “character_socioeconomic_status,” supporting searches for diverse character representations. These structured fields, when combined with the semantic search capabilities of the media platform 100, allow for complex queries such as “movies with a middle-aged female lawyer as the protagonist” or “TV shows featuring multicultural ensemble casts in urban settings.”

In one or more embodiments of the invention, the character and cast analysis engine 162 is further configured to handle the additional complexity of TV series, which have a hierarchical structure comprising series, seasons, and episodes. This capability, referred to as “TV Trellis,” enables the engine 162 to extract specific episode-level, season-level, and series-level media perspectives. For example, the engine 162 may initially use a show's pilot episode as a surrogate for first-cut analysis, but can subsequently analyze characters across the entire series. This comprehensive approach allows for search functionality across episodes and seasons, as well as significantly enriched series-level summaries. For instance, the engine 162 may analyze all characters from the entire series, providing a holistic view of character development and relationships throughout the show's run. This multi-level analysis enables more nuanced queries and insights, such as tracking character arcs across seasons or identifying recurring themes at both the episode and series levels.

### Multi-Dimensional Features Media Perspectives

In one or more embodiments of the invention, the setting and time classification engine 163 includes functionality to create and store multi-dimensional features documents in the document repository 181. These documents provide a structured data representation of detailed spatial and temporal contexts within the content, incorporating automated detection and categorization of story locations and time periods. The engine 163 employs advanced natural language processing and machine learning algorithms to analyze dialogue, visual cues, and metadata to identify and classify various settings and time periods depicted in media items.

The setting and time classification engine 163, in one or more embodiments, includes functionality to differentiate between the time period in which a story is set and the time period in which the media item was produced. This distinction is captured in separate fields within the structured data representation, allowing for nuanced analysis of historical accuracy, anachronisms, and the evolution of storytelling techniques over time. For example, the engine 163 may identify a film produced in 2022 that is set in the 1950s, storing both the production year and the depicted time period as distinct attributes.

In one or more embodiments of the invention, the prompt generation module 153 utilizes identified elements from the media's dialogue, visual content, or textual descriptions to craft prompts that guide the large language model (LLM) cluster 154. These prompts are designed to extract not only explicit mentions of locations and time periods but also implicit indicators, such as cultural references, technological advancements, or historical events that may suggest a particular setting or era.

The setting and time classification engine 163, using the large language model cluster 154, generates structured data capturing various temporal and spatial dimensions of the media items with a high degree of granularity. For instance, the engine 163 may classify locations hierarchically, from broad categories like “urban” or “rural” to specific neighborhoods within cities. Similarly, time periods may be categorized with varying levels of specificity, from broad eras like “Renaissance” to precise years or even seasons within a year.

In one or more embodiments, the setting and time classification engine 163 includes functionality to identify and categorize fictional or speculative settings and time periods. This may involve recognizing and classifying alternate history scenarios, futuristic settings, or entirely fictional worlds. The engine 163 may employ a combination of keyword analysis, context interpretation, and comparison to known historical and geographical data to accurately categorize these non-standard settings and time periods.

The structured data representations generated by the setting and time classification engine 163 enable multi-dimensional queries that can combine spatial, temporal, and production-related attributes. For example, users could search for “science fiction movies set on Mars, produced in the 1960s” or “contemporary dramas set in 19th century London.” This document structure supports granular classification for content discovery, trend analysis, and other applications within the media platform 100.

### Brand Safety Media Perspectives

In one or more embodiments of the invention, a brand safety engine (not shown) of the media perspective services 160 includes functionality to create and store documents concerning “brand safety.” As an example, these documents may be utilized in assessing and categorizing content based on various brand safety categories to ensure that digital advertising is not placed next to potentially harmful content, thereby maintaining brand reputation and minimizing negative publicity.

In one or more embodiments of the invention, the brand safety engine includes functionality to identify and categorize potentially sensitive or controversial content within media items using advanced natural language processing and computer vision techniques. For example, the engine may analyze dialogue, visual scenes, and contextual cues to detect instances of profanity, violence, or other sensitive topics. For example, when processing a popular crime drama series, the engine might identify a scene containing mild violence, capturing details such as the timestamp, severity, description of the action, relevant dialogue, visual elements, duration, audience rating, and recommendations for ad placement.

The prompt generation module 153 utilizes elements identified from media content, such as scenes depicting intense content or mature themes, to craft prompts. These prompts guide the large language model (LLM) cluster 154 to generate structured data representations that categorize and detail the type of brand safety concerns present in media content. This might involve categorizing scenes that include sensitive issues like substance use or controversial topics, ensuring that these tags are accurately reflected in the structured data.

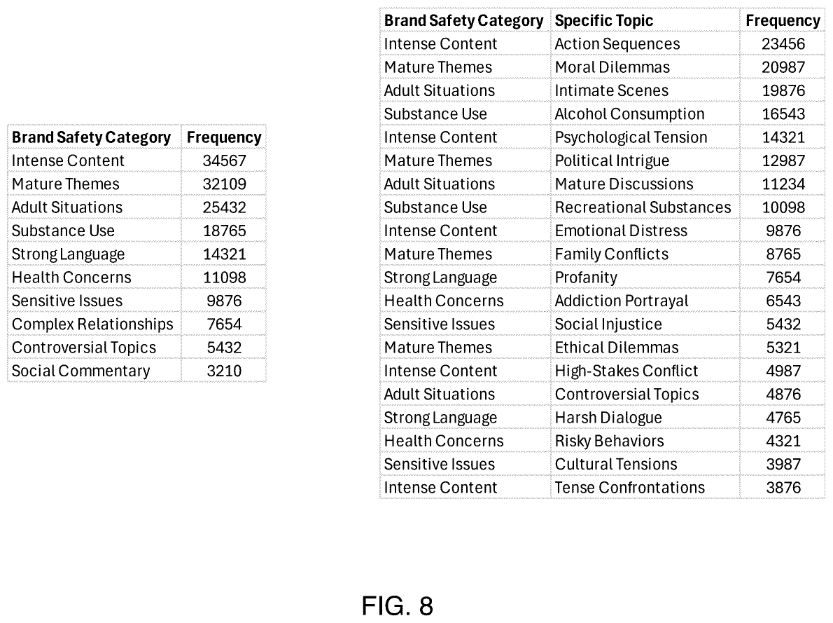

FIG. 8 is a depiction of the structured output derived from this process, listing various brand safety categories such as “Intense Content,” “Mature Themes,” and “Substance Use,” alongside their frequencies within the media content catalog based on generated brand safety documents. This table also breaks down these categories into more specific topics, like “Moral Dilemmas” under Mature Themes or “Alcohol Consumption” under Substance Use, providing granular insights into the content themes that are necessary to enable appropriate content classification and filtering.

In one example, these structured data representations enable the platform to offer tools for advertisers to filter and select environments that align with their brand values and avoid those that could pose risks to their image. For instance, an advertiser looking to avoid association with content featuring drug use can effectively utilize these brand safety documents to prevent ad placement alongside such content. In another example, these documents assist in content governance, helping content managers to identify and address content that frequently features sensitive or controversial themes, ensuring compliance with broadcasting standards and regulations. The brand safety documents not only facilitate safer advertising practices but also enhance content management, search, and recommendation, resulting in a safer and more appropriate media environment.

### Microgenre Media Perspectives

In one or more embodiments of the invention, the micro-genre classification engine 166 includes functionality to create and manage documents related to “microgenres.” These documents provide a structured data representation of highly specific or niche subcategories of broader genres or subgenres within the media content, characterized by unique combinations of themes, styles, settings, time periods, and narrative structures.

The prompt generation module 153 leverages identified media features, such as thematic elements, narrative details, and stylistic nuances, to formulate prompts that guide the large language model (LLM) cluster 154. The cluster is configured to process these prompts to generate structured data representations that distinctly categorize media into microgenres. For example, this may involve identifying a unique narrative like “millennial coming-of-age” or “urban mystery drama,” which are significantly defined by their specific thematic and narrative attributes.

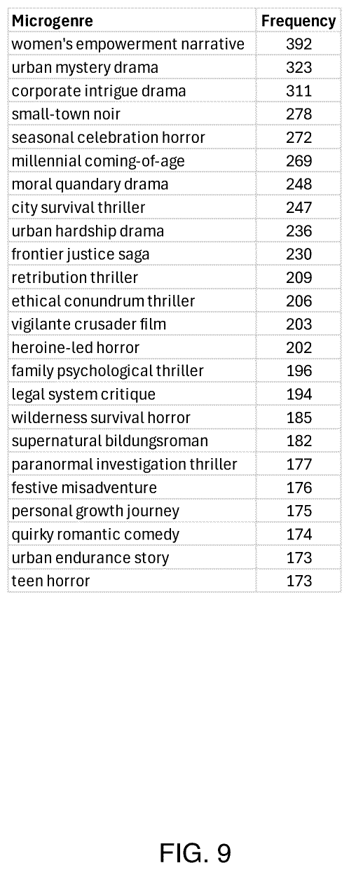

FIG. 9 demonstrates the application of this process by listing various microgenres along with their occurrence frequencies in the document repository 181. This figure illustrates the diversity and specificity of microgenres such as “women's empowerment narrative,” “corporate intrigue drama,” and “small-town noir,” showcasing the ability of the system to pinpoint precise genre classifications that go beyond traditional genre labels. This categorization helps in tailoring content discovery and recommendations to user preferences with high precision, enhancing user engagement and satisfaction.

These microgenre documents enable the platform to offer nuanced search capabilities and detailed audience insights. Advertisers and content creators can utilize these insights to target specific audiences or develop content that aligns with trending microgenres. Moreover, this detailed classification provided content managers and marketers with refined tools for analysis of content trends.

### Vibes Media Perspectives

In one or more embodiments of the invention, the thematic and tonal analysis engine 164 includes functionality to create and manage documents associated with the media perspective known as “vibes.” These documents provide a structured data representation of the general mood, atmosphere, or emotional tone of a movie or TV show, detailing the combined effect of various elements that make viewers feel a certain way.

The prompt generation module 153, utilizing the capabilities of the large language model (LLM) cluster 154, crafts prompts based on identified elements from the media's dialogue, background noises, sound design, and visual cues. These prompts facilitate the generation of structured data representations that categorize and detail the emotional and atmospheric nuances of media content. For example, a film might be characterized by vibes such as “melancholic” due to its somber theme music and dim lighting, or “thrilling” because of its fast-paced action scenes and suspenseful dialogue.

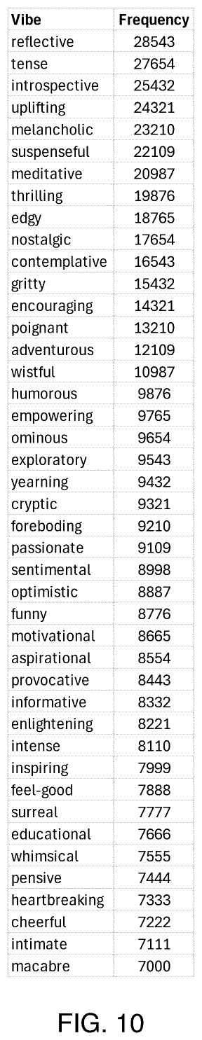

FIG. 10 demonstrates the application of this categorization process by listing various vibes along with their occurrence frequencies in the document repository 181. This figure showcases a range of vibes such as “reflective,” “introspective,” “uplifting,” and “melancholic,” each quantified by their frequency of appearance across different media items. This precise identification and categorization allow for enhanced content discovery and recommendation, as users can search for media based on the specific emotional tone they wish to experience.

These vibe documents stored in the document repository 181 enable the platform to offer refined search capabilities and detailed audience insights. Advertisers, content creators, and curators can use these insights to better align content with audience mood preferences, tailor marketing strategies, or even guide the creative direction of new content. Additionally, this detailed vibe classification helps in analyzing viewer engagement and preferences, providing valuable feedback for content strategy and development.

### Genrative Media Perspectives

In one or more embodiments of the invention, the plot and action detection engine 165 includes functionality to generate and manage documents pertaining to the “genrative” media perspective. These documents capture a structured data representation of genre and narrative-based attributes such as tropes, themes, and novel genres, which are crucial for understanding deeper narrative elements that transcend traditional genre classifications.

The prompt generation module 153 leverages comprehensive metadata and descriptive text resources to formulate prompts that direct the large language model (LLM) cluster 154 to yield structured data that classifies media content into detailed genres and identifies key narrative elements, such as themes and tropes that define the story's depth and complexity.

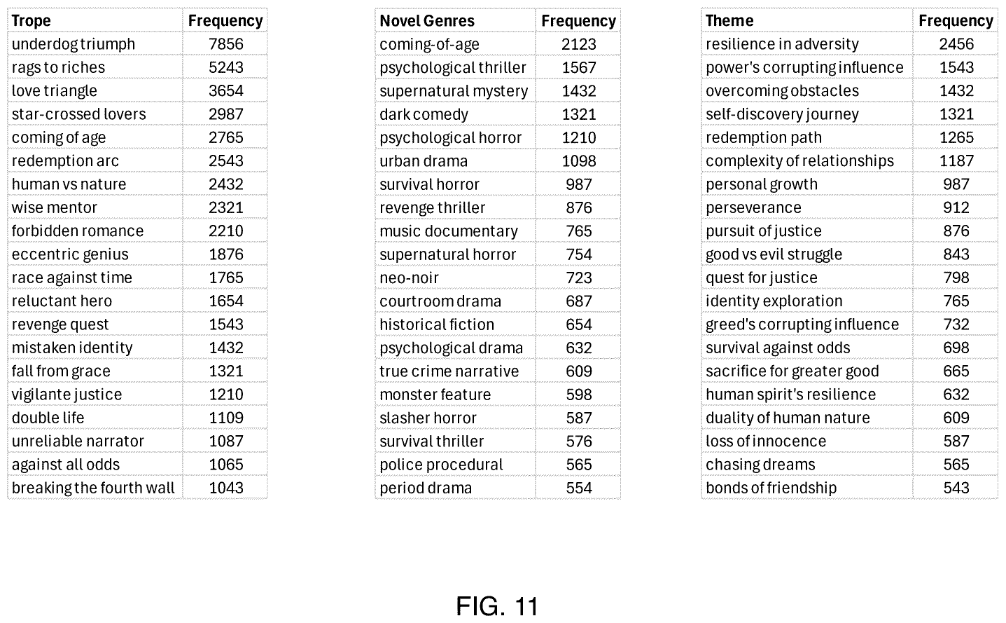

FIG. 11 illustrates the application of this process, displaying the frequency of various tropes, novel genres, and themes across the media catalog. For instance, the table lists tropes like “underdog triumph” and “rags to riches,” novel genres such as “coming-of-age” and “psychological thriller,” and themes like “resilience in adversity” and “power's corrupting influence.” Each category is quantified by its frequency, highlighting the prevalent narrative structures, thematic explorations, and innovative genre formulations within the media content.

These genrative documents, stored in the document repository 181, enable enhanced content discovery and recommendation by allowing users to search for media based on specific narrative themes or tropes. Additionally, this detailed categorization aids advertisers and content creators in targeting audiences who prefer particular narrative elements or thematic explorations. It also provides content strategists and marketers with valuable insights into trending narratives and genre innovations.

### Action Media Perspectives

In one or more embodiments of the invention, the plot and action detection engine 165 includes functionality to generate and manage documents denoting specific types of action depicted in media content. These documents are useful in understanding the dynamic elements of storytelling through structured data representation of action categories and specific actions within varied settings.

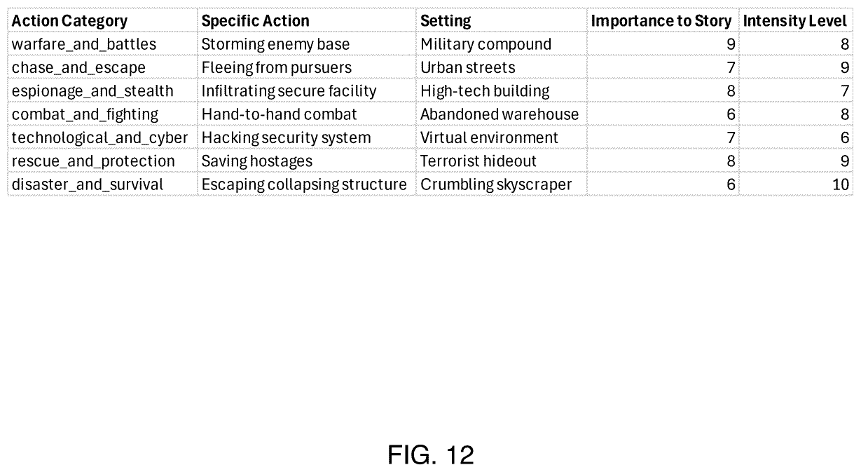

The prompt generation module 153, leveraging the capabilities of the large language model (LLM) cluster 154, crafts prompts that utilize subtitles, audio descriptions, computer vision analysis of the video and/or other aspects of the media items to categorize actions based on their nature and intensity. This model processes these prompts to generate structured data that specifically captures the essence of action scenes, ranging from chase sequences to intricate combat scenarios, and assigns them categorical labels such as “warfare and battles,” “espionage and stealth,” and “disaster and survival.” FIG. 12 illustrates this application by detailing various action categories, specific actions, settings, and their respective importance to the story and intensity levels. For instance, the table lists actions like “Storming enemy base” within a “Military compound” setting, rated with high importance and intensity, or “Infiltrating secure facility” in a “High-tech building,” showcasing the system's ability to identify and contextualize actions within the narrative framework.

These action documents stored in the document repository 181 allow for enhanced content discoverability and user engagement by enabling searches based on action intensity or story relevance. For instance, users interested in high-stakes scenarios may search for content with actions categorized under “disaster and survival,” specifically looking for scenes like “Escaping collapsing structure” which is noted for its high intensity and crucial narrative role.

### Rave Reviews Media Perspectives

In one or more embodiments of the invention, the thematic and tonal analysis engine 164 includes functionality to analyze and categorize professional and amateur reviews of media titles into a structured data representation called “rave reviews.” These documents are utilized by the system in understanding viewer sentiment, capturing the essence of the vibes, perspectives on plot, and other details conveyed through reviews that enhance our comprehension of various media aspects.

The thematic and tonal analysis engine 164 utilizes the prompt generation module 153 to process detailed descriptive inputs from reviews. These prompts facilitate the large language model (LLM) cluster 154 to extract and structurally categorize sentiments and detailed viewpoints about the media titles, ranging from emotional responses to critical analysis of narrative structures.

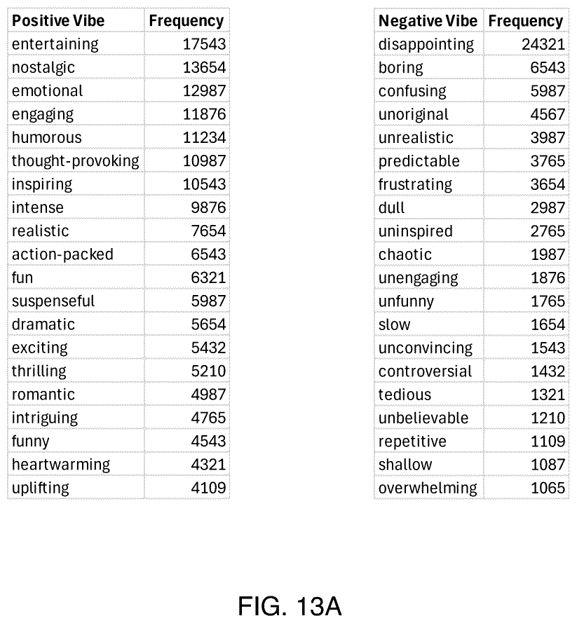

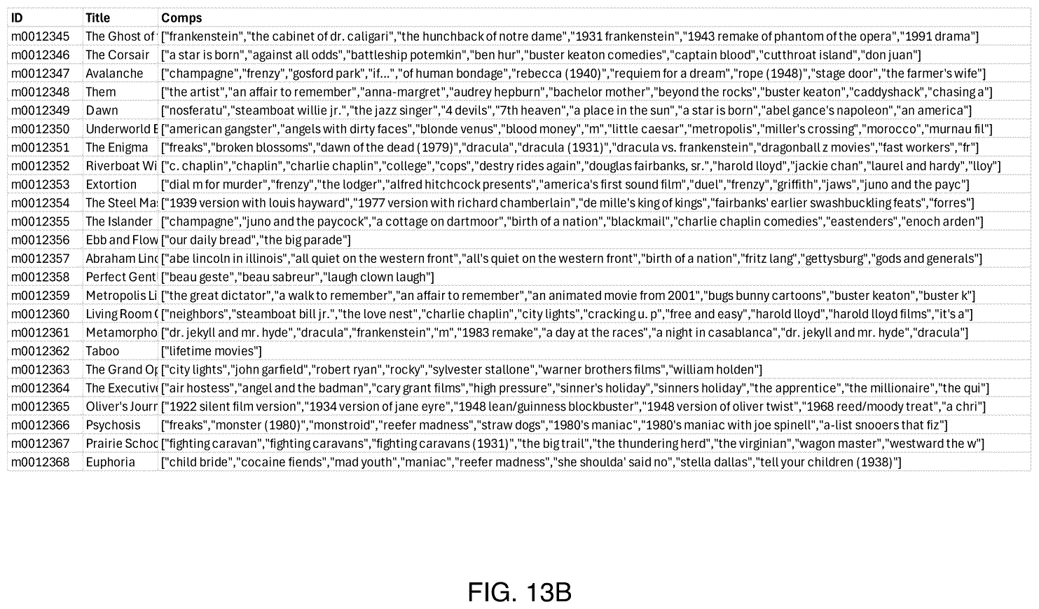

FIG. 13A and FIG. 13B illustrate examples of structured rave review documents and insights derived from these documents. FIG. 13A lists frequencies of specific positive and negative vibes attributed to media content, as described in reviews. For instance, ‘entertaining’ and ‘disappointing’ appear as the most frequently mentioned positive and negative vibes, respectively, highlighting predominant audience reactions. FIG. 13B shows a detailed breakdown of reviews, where each entry includes comprehensive data such as the title of the media, an abstract of the review, and a concise summary that encapsulates the essence of the review, including whether it conveys the narrative and various sentiment ratings.

These rave review documents, stored in the document repository 181, enable refined content discovery, recommendation, and audience sentiment analysis. By categorizing reviews according to their sentiment and narrative detail, the system is enabled to identify and surface content that matches reviewers having an affinity with a user or avoid titles with predominantly negative receptions by such reviewers. Moreover, this data aids content creators and marketers by providing insights into the public reception of different titles, assisting in generating advertisement or promotional activities and content development. Analyzing trends in viewer sentiment also helps in predicting future content popularity and adjusting marketing strategies accordingly.

### Data Validation and Quality Control

In one or more embodiments of the invention, the data validation and quality control module 156 includes functionality to evaluate the coherence of generated structured data representations. The module 156 employs a set of predefined rules and heuristics to identify inconsistencies within and across documents. For example, the module 156 may compare character names, ages, and relationships across different scenes or episodes of a TV series to ensure consistent representation throughout the media item.

In one or more embodiments of the invention, the data validation and quality control module 156 includes functionality to identify missing or incomplete fields in the structured data. This function may scan through generated documents to detect undefined attributes, such as unspecified character occupations or ambiguous location descriptions. For instance, if a character's age is mentioned in one scene but not recorded in the character's profile, the module 156 may flag this as an incomplete data point for further investigation or automated filling.

In one or more embodiments of the invention, the data validation and quality control module 156 includes functionality to assign reliability metrics to extracted information. These algorithms may consider factors such as the clarity of the source material, the frequency of mention, and the model's certainty in its classification or extraction process. For example, if a character's profession is explicitly stated multiple times in clear dialogue, it might receive a high confidence score. Conversely, if a character's backstory is only vaguely alluded to, the extracted information might be assigned a lower confidence score.

In one or more embodiments of the invention, the data validation and quality control module 156 includes functionality to compare extracted information across multiple data sources within the media platform 100. This function may corroborate details between different media items, external databases, or user-generated content to enhance the accuracy of the structured data representations. For instance, the module 156 might cross-check historical events mentioned in a period drama against a verified historical database to validate the accuracy of the depicted time period.

In one or more embodiments of the invention, the data validation and quality control module 156 includes functionality to leverage knowledge graphs as a representation for associating and validating information. These knowledge graphs can capture complex relationships between entities, events, and concepts extracted from the media content, allowing for more sophisticated validation. By utilizing this graph-based structure, the module 156 is configured to perform consistency checks across a wide network of interrelated documents, identifying discrepancies or confirming the coherence of extracted information. This enhances the accuracy of individual data points and ensures the overall logical consistency of the generated documents across multiple media items and perspectives.

In one or more embodiments of the invention, the data validation and quality control module 156 includes functionality to prioritize data for manual review based on the results of its automated checks and confidence scoring. This function may generate reports or alerts highlighting inconsistencies, incomplete data, or low-confidence extractions that require human intervention. For example, if the module 156 detects a significant discrepancy in a character's age across different episodes of a TV series, it may flag this issue and elevate it for review by content managers or data curators within the media platform 100.

### Content Similarity

In one or more embodiments of the invention, the content similarity engine 157 includes functionality to quantify thematic, stylistic, and narrative similarities between media items and to identify derivative works or strong influences. The engine 157 may be configured to analyze the aspects of the media item (e.g., subtitles, audio description data, video, etc) as well as documents generated by various components of the autodata generation system 150 in order to generate new documents representing content similarity based on plot elements, character archetypes, setting descriptions, and stylistic markers. These may include computed similarity scores between different media items in the media catalog.

In one or more embodiments of the invention, the content similarity engine 157 is configured to identify derivative works or strong influences by detecting statistically significant overlaps among plot points, character traits, and thematic elements. The engine 157 may analyze temporal relationships between release dates of potentially related works to establish a chronology of influence. For instance, if two media items share highly similar plot structures and character archetypes, and one was released significantly earlier than the other, the engine 157 might flag the later work as potentially derivative or strongly influenced by the earlier work.

The content similarity engine 157, in one or more embodiments, includes functionality to generate a graph representation of media item relationships. In this graph, nodes may represent individual media items, while edge weights indicate the strength of similarity or influence between connected nodes. This graph representation can be used to represent and visualize complex networks of related content, enabling the system to surface related narratives, track the evolution of themes across different works, or identify new content based on similarities between media items.

### Baseline Semantic Search

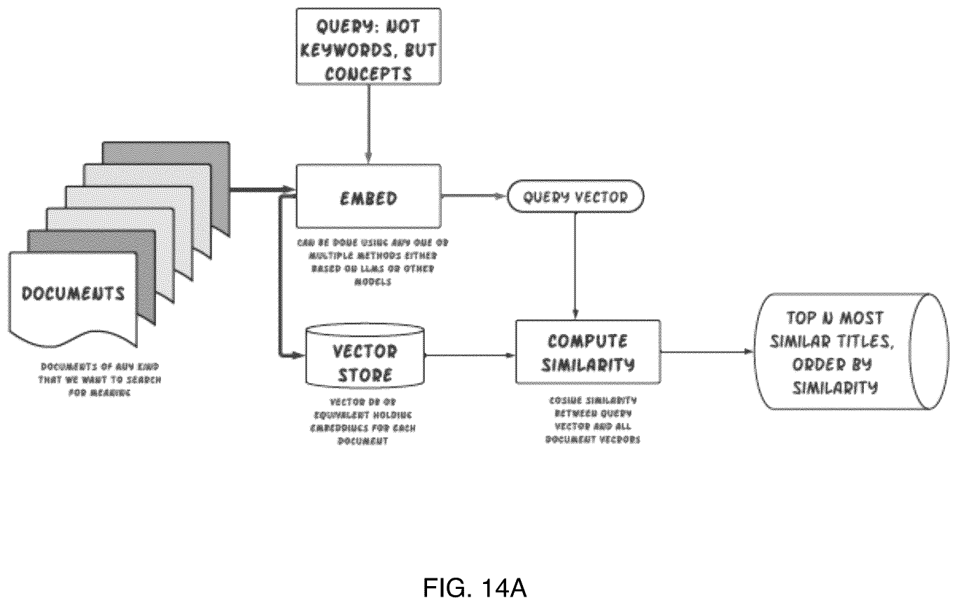

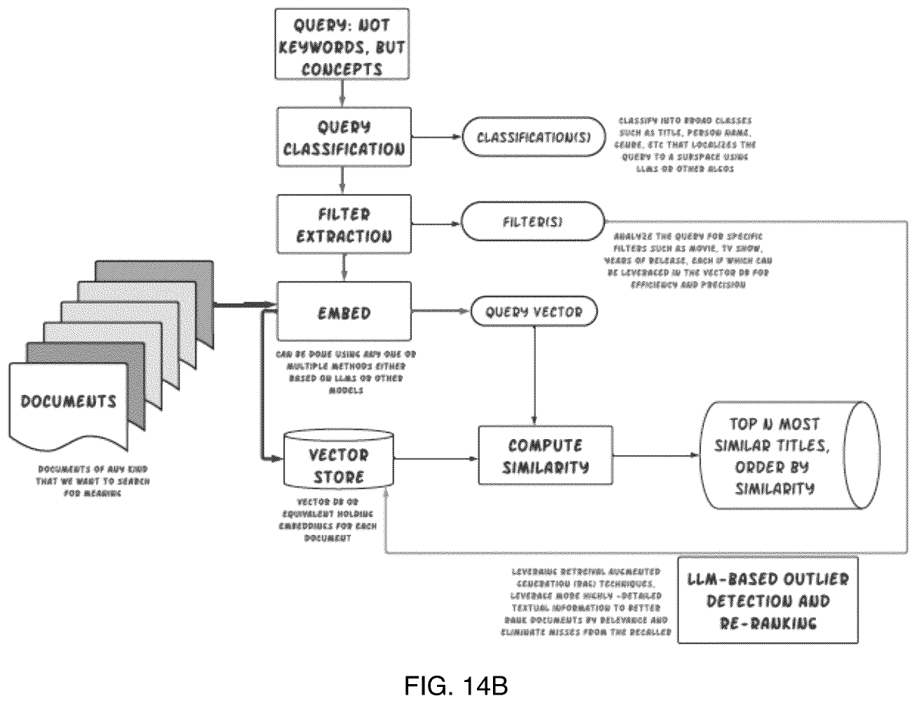

FIG. 14A depicts an example of a baseline semantic search system, in accordance with one or more embodiments of the invention. The system comprises several interconnected components that work together to process queries and return relevant results.

In one or more embodiments, the system includes a document repository, which may be implemented as part of the document repository 181 within the data services 180. This repository contains the collection of documents to be searched. Examples of documents may include, but are not limited to, documents representing a diverse array of media perspectives such as summary hierarchy, guardrails, brand safety, multi-dimensional features, microgenres, vibes, genrative, and more.

The system, in one or more embodiments, incorporates an embedding component, labeled as “EMBED” in FIG. 14A. This functionality may be provided by the encoder model 142 within the indexer service 141 of the augmented semantic search system 140. The embedding component is configured to generate vector representations for both the documents in the repository and the input queries. Various embedding techniques may be employed, such as word embeddings, sentence embeddings, or document embeddings.

In one or more embodiments, the system includes a vector store, as shown in FIG. 14A. This component may be implemented as part of the vector repository 182 within the data services 180. The vector store is designed to efficiently store and retrieve the vector representations of the documents, and may use various data structures optimized for high-dimensional vector storage and retrieval.

The system, in one or more embodiments, accepts user queries represented by the “QUERY: NOT KEYWORDS, BUT CONCEPTS” box in FIG. 14A. This indicates that the system is designed to understand and process queries based on their conceptual meaning rather than relying solely on keyword matching. The query is then embedded into a vector representation, labeled as “QUERY VECTOR” in the figure, using the same embedding process applied to the documents.

In one or more embodiments, the system includes a similarity computation component, labeled as “COMPUTE SIMILARITY” in FIG. 14A. This functionality may be provided by the recaller service 146 within the augmented semantic search system 140. This component is configured to calculate the similarity between the query vector and the document vectors stored in the vector store. Various similarity metrics may be used, such as cosine similarity, Euclidean distance, or dot product.

The system, in one or more embodiments, incorporates a ranking component, which is implied by the “TOP N MOST SIMILAR TITLES, ORDERED BY SIMILARITY” box in FIG. 14A. This component is responsible for ordering the search results based on their similarity scores. It returns the top N most similar documents, where N is a configurable parameter, ordered by their similarity to the query.

In one or more embodiments, the system addresses the complexity arising from multiple documents representing a single entity (e.g., a show or movie) in the search space. The system may employ various methods to handle this scenario. One approach involves selecting the most similar variant, where for each entity, the system identifies all associated documents and their respective similarity scores to the query vector, then selects the document with the highest similarity score to represent that entity in the final ranking. Alternatively, the system may compute an average similarity score across all documents representing the same entity, using this average score to rank the entity in the search results. Another method involves frequency-based re-ordering, where the system counts the frequency of each entity's appearance in the top K results (where K is a predetermined number larger than N) and adjusts the final ranking based on a weighted combination of the similarity score and the frequency count. The system may also employ hierarchical similarity computation, first computing similarity at the document level, then aggregating these scores at the entity level using a predefined aggregation function such as max, mean, or a weighted sum based on document importance. The system may dynamically select among these methods based on factors such as query type, content category, or user preferences.

As illustrated in FIG. 14A, the baseline semantic search system operates by first embedding the user's conceptual query into a vector representation. This query vector is then compared against the pre-computed document vectors stored in the vector store. The similarity computation component calculates the similarity between the query vector and all document vectors, or a subset thereof. Finally, the system ranks the documents based on their similarity scores and returns the top N most similar titles, ordered by similarity.

### Augmented Semantic Search

FIG. 14B depicts an example of an augmented semantic search system, in accordance with one or more embodiments of the invention. The system comprises several interconnected components that work together to process queries and return relevant results, including those enabling query classification, filter extraction, and LLM-based outlier detection and re-ranking.

### Query Classification

In one or more embodiments of the invention, the augmented semantic search system includes a query classification system 143. This system is designed to enhance the search process by analyzing and categorizing the input query before it is embedded and used for similarity matching.

The query classification system 143 comprises functionality to receive a search request and generate a structured classification of the query. As illustrated in FIG. 14B, the “QUERY CLASSIFICATION” step occurs after the initial query input but before the embedding process. This classification step aims to understand the conceptual nature of the query beyond mere keywords and to classify the input query into one or more predefined classifications.

Examples of classifications can include, but are not limited to: genre (e.g., action, comedy, drama, science fiction), time period (e.g., 1980s, medieval, futuristic), mood (e.g., uplifting, suspenseful, romantic), target audience (e.g., children, young adults, mature viewers), content type (e.g., movie, TV show, documentary, short film), production style (e.g., live-action, animation, stop-motion), cultural context (e.g., Western, Asian cinema, Bollywood), thematic elements (e.g., coming-of-age, revenge, exploration), technical aspects (e.g., cinematography, special effects, sound design), critical reception (e.g., award-winning, cult classic, critically acclaimed), creator-related (e.g., specific director, actor, or studio), and adaptation source (e.g., based on a book, comic, or true story).

For purposes of this disclosure, in one or more embodiments of the invention, there is a distinction between classification and filter extraction in the context of query processing. While classification may apply to the query as a whole, categorizing it into one or more broad concepts or themes, filter extraction identifies specific entities or attributes within the query that can be used to narrow down the search results. For example, in a query like “award-winning French movies from the 1960s,” the classification might identify this as a request for critically acclaimed foreign films from a specific time period, while filter extraction would isolate “French,” “award-winning,” and “1960s” as specific criteria to be applied to the search. The process of filter extraction is described in other areas of this disclosure and works in conjunction with classification to provide a comprehensive understanding of the user's search intent.

In one or more embodiments, the query classification system 143 utilizes large language models (LLMs) to perform the classification task. The system may generate a prompt comprising the search request, a set of predefined categories, descriptions of these categories, and a definition of a structured classification format. This prompt is then used as input to an LLM, which generates a classification object representing the categorization of the query string in the structured format.

The classification object may include various attributes such as topic, intent, complexity, or any other relevant characteristics that can inform the subsequent search process. For example, as shown in FIG. 14B, the classification step may identify attributes “such as title, person name, genre, etc.” that categorize the query to a subspace.

In one or more embodiments, the query classification system 143 may employ multiple classification models or techniques to provide a comprehensive understanding of the query. This could involve using different LLMs specialized for various aspects of classification, or combining rule-based and machine learning approaches.

In one or more embodiments of the invention, the query classification system 143 employs a diverse array of classification approaches to perform the categorization task. While many examples provided in the present disclosure involve large language models (LLMs), any number of other models may be utilized. The system may be configured to utilize various machine learning-based classification methods, including but not limited to fine-tuned small language models (SLMs), traditional supervised learning algorithms, and ensemble methods. In one or more embodiments of the invention, the system utilizes different models specialized for various aspects of classification, and combines both rule-based and machine learning approaches.

In one or more embodiments of the invention, the embedding process for query vectors is enhanced by incorporating classification information. Traditionally, embedding techniques typically use the raw search string as the sole input for generating query vectors. However, the augmented semantic search system leverages the classifications generated by the query classification system 143 as additional inputs to the embedding process. This method, as illustrated in FIG. 14B, allows for a more nuanced and context-aware vector representation of the query. By considering the classified attributes of the query, such as genre, time period, or thematic elements, the embedding process can generate a query vector that more accurately captures the conceptual essence and intent of the search. This approach enables the system to create richer, more informative query embeddings that can lead to improved similarity matching and more relevant search results.

### Multi-Classification

In one or more embodiments of the invention, the system includes a multi-classification analyzer service 144. This service is designed to handle complex queries that may span multiple classifications or topics. For instance, given a query like “I love movies filmed in France and also racecars”, the multi-classification analyzer service 144 can recognize that this query encompasses two distinct topics: French cinema and racecars.

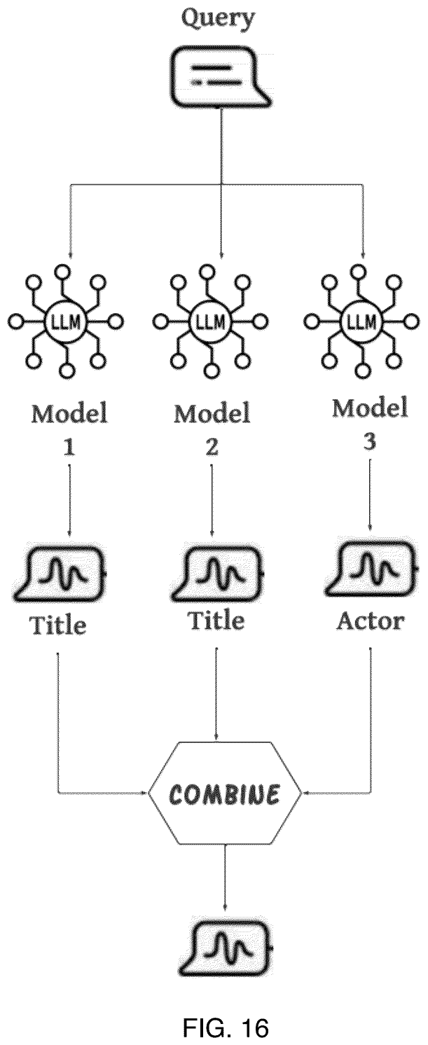

In such cases, the multi-classification analyzer service 144 may break down the original query into multiple concurrent search requests, each focused on a specific classification. This approach allows for more nuanced and accurate searching, as each sub-query can be processed and embedded separately, taking into account its specific context and classification. FIG. 16 illustrates this process, showing how a single query can be processed by multiple Large Language Models (LLMs) in parallel.

The multi-classification analyzer service 144 is particularly useful when dealing with multiple concepts that are unrelated and would have a negligible chance of co-occurring in any single variant represented by an embedding. Given the sheer number of possible concept combinations, it may be impractical or infeasible to cover every possible combination with pre-computed embeddings. By breaking down complex queries into their constituent parts, the system is configured to effectively handle queries that combine disparate concepts, ensuring that each aspect of the query is properly represented in the search process. This method not only improves the accuracy of results for complex, multi-faceted queries but also maintains efficiency by avoiding the need to pre-compute embeddings for every possible combination of concepts.

As depicted in FIG. 16, the multi-classification analyzer service 144 may employ multiple LLM models, each specializing in a different aspect of query classification. In the example shown, Model 1 and Model 2 are both focused on identifying titles, while Model 3 is specialized for actor recognition. This multi-model approach allows the system to simultaneously analyze the query from different perspectives, potentially uncovering multiple relevant classifications.

Each LLM model processes the query independently, generating its own classification output. In the case illustrated in FIG. 16, Models 1 and 2 produce title-related classifications, while Model 3 identifies actor-related information. This parallel processing enables the system to efficiently handle complex queries that may contain multiple elements or span various domains.

After the individual models have processed the query, the multi-classification analyzer service 144 combines the results. This combination step, represented by the “COMBINE” node in FIG. 16, involves merging the outputs from the different models into a unified classification. The comprehensive classification object may include a unified classification hierarchy, confidence scores for each classification, potential conflicts or overlaps between classifications, and a set of suggested query refinements based on the multiple classifications identified. Using this approach, the augmented semantic search system is enabled to provide more accurate and contextually relevant search results, especially for complex or multi-faceted queries.

The final output of this multi-classification process is a multifaceted representation of the query that captures its various aspects. This comprehensive classification can then be used to inform subsequent stages of the search process, such as filter extraction and result ranking, enabling the system to provide more accurate and relevant search results for complex, multi-faceted queries. This multi-classification approach enables the system to handle a wide range of query complexities, from simple, single-topic searches to intricate, multi-domain queries.

### Filter Extraction

In one or more embodiments of the invention, the augmented semantic search system includes a filter extraction system 145. This system is designed to enhance the search process by identifying and extracting specific filters from the input query to refine and constrain the search results. The filter extraction system 145 comprises functionality to analyze the search request and generate a structured set of filters based on the query content. As illustrated in FIG. 14B, the “FILTER EXTRACTION” step occurs before the embedding process. This filter extraction step aims to identify specific entities, attributes, or constraints within the query that can be used to narrow down the search space and improve result relevance.

In one or more embodiments of the invention, the filter extraction system 145 is capable of identifying various types of filters from the query. These may include, but are not limited to: temporal filters for extracting date ranges, specific years, or time periods; spatial filters for identifying geographical locations or settings; entity-specific filters for recognizing names of people, organizations, or other named entities; attribute filters for extracting specific characteristics or properties; numerical filters for identifying quantitative constraints or ranges; and categorical filters for recognizing genre, type, or category-related information in the search request. One commonly applied filter distinguishes between movies and television shows. This movie versus TV filter can play an important role in narrowing down the search space and tailoring results to the user's intended media type.

In one or more embodiments of the invention, the system 145 employs advanced natural language processing techniques to identify named entities, key phrases, and potential filter candidates within the query string. These extracted entities and phrases are then analyzed in the context of the entire query to determine their relevance as potential filters. The identified filter candidates are classified into predefined categories to facilitate their application in the search process. The classified filters are converted into a structured format, such as a JSON object, that can be easily interpreted and applied by the search engine. Each extracted filter is assigned a confidence score, indicating the system's certainty about the filter's relevance and accuracy.

In one or more embodiments of the invention, the filter extraction system 145 utilizes large language models (LLMs) to perform the filter extraction task. The system may generate a prompt comprising the search request, a set of predefined filter criteria, and a definition of a structured filter format. This prompt is then used as input to an LLM, which generates a filter object comprising a set of filters inferred for the query string in the structured format. The use of LLMs allows for a more detailed understanding of the query intent and enables the system to handle complex, multi-faceted search requests with greater accuracy.

In one or more embodiments of the invention, the filter extraction system 145 works in conjunction with other components of the augmented semantic search system to provide highly targeted and relevant search results. As shown in FIG. 14B, the extracted filters can be leveraged in the vector database for efficiency by narrowing down the search space before performing similarity computations, potentially improving both the speed and accuracy of the search process.

In one or more embodiments of the invention, the filter extraction system 145 contributes to improving the overall latency of the search process. By applying filters early in the search pipeline, the system can significantly reduce the volume of data that needs to be processed in subsequent stages. Each extracted filter has the potential to narrow down the search space, thereby decreasing the number of documents or embeddings that need to be considered during the similarity computation phase. This reduction in the amount of data to be processed can lead to substantial time savings, especially for large-scale datasets or complex queries. The efficiency gained through this filtering process allows the system to deliver faster response times while maintaining the quality and relevance of the search results, striking a balance between search accuracy and computational performance.

Furthermore, in one or more embodiments of the invention, the filter extraction system 145 can handle queries of varying complexity. For simpler queries, it may extract straightforward filters such as a specific title or person name. For more complex queries, it can identify multiple interconnected filters, such as a combination of genre, time period, and thematic elements. The system is designed to be flexible and adaptable, capable of processing both explicit filter criteria stated directly in the query and implicit filters that may be inferred from the context or intent of the search request.

In one or more embodiments, the filter extraction system 145 may also incorporate domain-specific knowledge to enhance its filter identification capabilities. For instance, in the context of media content searches, the system 145 may be configured to recognize and extract filters related to movie genres, TV show seasons, actor names, or director styles. This domain-specific functionality can be achieved through specialized training of the LLMs or through the integration of domain-specific rules and ontologies.

In one or more embodiments of the invention, the extracted filters are utilized in the post-retrieval processing of search results by the intelligent re-ranking system 147. After an initial set of results is obtained based on vector similarity, the intelligent re-ranking system 147 utilizes the extracted filters to refine and re-rank the search results, ensuring they closely match all aspects of the user's query. The intelligent re-ranking system 147 may comprise functionality to receive the initial result set from the recaller service 146 along with the filter object generated by the filter extraction system 145. It then analyzes each result in the initial set against the extracted filters, assigning a filter compliance score to each result based on how well it matches the filter criteria.

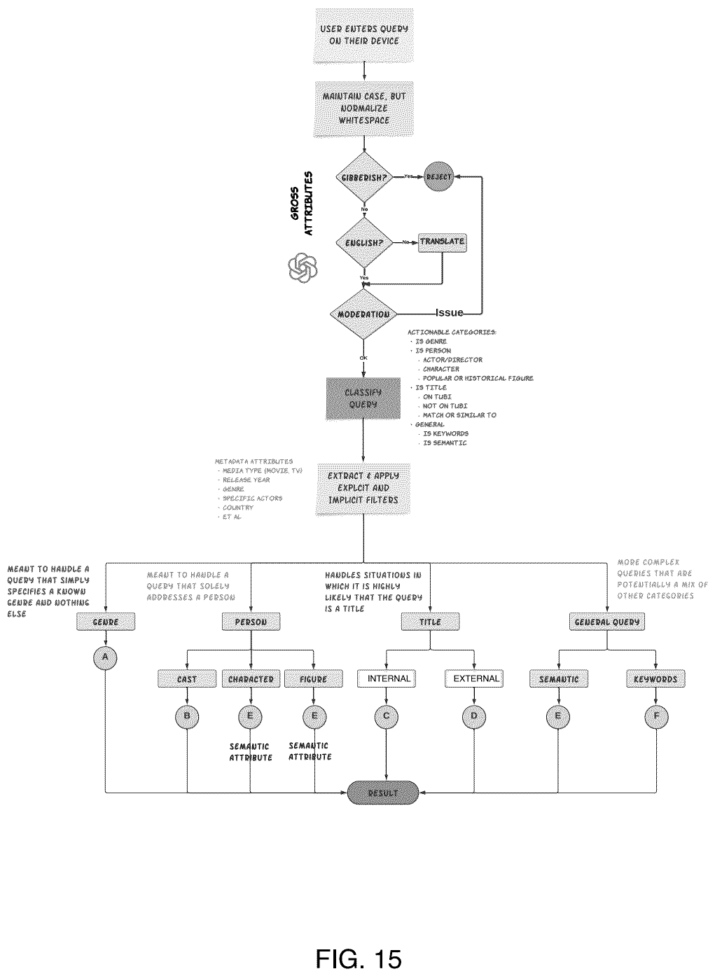

FIG. 15 illustrates an in-depth query handling process for integrated search, in accordance with one or more embodiments of the invention. The figure depicts a workflow that begins with user input and progresses through various stages of query processing, classification, and filter extraction.

In one or more embodiments, the process starts with the user entering a query on their device, which is received by the content API 110. The system then maintains the case of the query but normalizes whitespace, a task that may be performed by the query classification system 143. Following this, the query undergoes a series of checks represented by diamond-shaped decision points in the figure. The first check determines if the query contains gibberish, which may be executed by a sub-component of the query classification system 143. If gibberish is detected, the query is rejected. If the query passes this check, it is then evaluated to determine if it is in English. This language detection may be performed by another sub-component of the query classification system 143. Non-English queries are sent for translation, utilizing an external service integrated through the integration service 195.

The query then undergoes a moderation check, which may be implemented as part of the data validation and quality control module 156. If the query fails moderation, it is rejected. Queries that pass moderation proceed to the classification stage, labeled as “CLASSIFY QUERY” in the figure. This classification is performed by the query classification system 143, which categorizes the query into one or more predefined classes such as genre, person (further subdivided into cast, character, and figure), title, and general query types.

Following classification, the system moves to the “EXTRACT & APPLY EXPLICIT AND IMPLICIT FILTERS” stage, which is handled by the filter extraction system 145. This stage involves identifying and applying both explicit filters directly mentioned in the query and implicit filters inferred from the query's context. The filter extraction system 145 may leverage attributes such as media type, release year, genres, specific actors, and country, as listed in the figure.

The lower portion of FIG. 15 illustrates how the system handles different types of queries based on their classification. For queries classified as addressing a known genre, the system may utilize a specific processing path (labeled ‘A’ in the figure) optimized for genre-based searches. Queries focused on persons are further categorized into cast, character, or historical figure, with each category potentially employing different semantic attributes in the search process (paths ‘B’, ‘E’, and ‘F’). Title-based queries are divided into in-house (which may refer to content in the in-house media catalog) and external categories (paths ‘C’ and ‘D’), indicating that the system can handle in-house and external title searches differently. External content queries are processed through semantic and keyword-based paths (‘E’ and ‘F’), allowing for a comprehensive search approach.

### Re-Ranking and Outlier Detection

In one or more embodiments of the invention, the augmented semantic search system includes an intelligent re-ranking system 147. This system is designed to refine and optimize the search results obtained from the initial vector similarity matching process, ensuring that the final results presented to the user are not only semantically relevant but also precisely aligned with the user's search intent and any specific constraints or preferences expressed in the query.

The intelligent re-ranking system 147 comprises functionality to receive an initial match set of embeddings from the recaller service 146 and process this set to produce a re-ranked list of results that more accurately reflects the nuances of the user's query. In one or more embodiments, the intelligent re-ranking system 147 operates by generating a re-ranking prompt that encapsulates the essential elements of the search context. This prompt typically includes the query embedding, which represents the user's search intent in a dense vector space, and the match set of embeddings returned by the initial similarity search.

The system may incorporate additional contextual information into the re-ranking prompt to enhance its effectiveness. This can include the classification object generated by the query classification service 143, which provides a high-level categorization of the query, and the filter object produced by the filter extraction service 145, which captures specific constraints or preferences expressed in the query. In some embodiments, the system may also incorporate user profile data, historical search behavior, trending topics, or other relevant contextual information to further refine the ranking process.

In one or more embodiments, the intelligent re-ranking system 147 further incorporates key performance indicators (KPIs) and performance metrics into the re-ranking process. Examples of metrics utilized in re-ranking can include, but are not limited to, total viewing time (TVT), which provides insights into user engagement and content popularity, completion rate, indicating how often users finish watching a piece of content, and click-through rate (CTR) for content thumbnails or descriptions. The system may also consider metrics such as user rating scores or the frequency of content shares. By leveraging these metrics, the system can further refine the ranking of search results, adjusting the order based on a combination of semantic relevance and performance data.

Once the re-ranking prompt is generated, the intelligent re-ranking system 147 executes a large language model (LLM) using this prompt. The LLM analyzes the relationships between the query embedding and each embedding in the match set, considering the additional context provided. Based on this analysis, the LLM generates a re-ranked match set of embeddings, effectively reordering the results to better align with the user's search intent and any specified constraints.

In one or more embodiments, the intelligent re-ranking system 147 includes functionality for outlier detection. This process involves generating an outlier detection prompt that includes the query embedding, the match set of embeddings, and contextual information derived from the classification and filter objects. The LLM processes this prompt to generate an outlier score for each embedding in the match set. The system then applies a dynamic outlier threshold, which is adjusted based on the query classification and the distribution of outlier scores. Embeddings with scores exceeding this threshold are identified as potential outliers.

The system further analyzes the semantic relationships between the identified outlier embeddings and non-outlier embeddings. Based on both the outlier scores and the semantic distances from non-outlier embeddings, certain outlier embeddings may be selectively excluded from the final result set. This process helps to remove results that, while potentially semantically similar, may not align well with the user's actual search intent or the specific context of the query.

In one or more embodiments of the invention, the intelligent re-ranking system 147 employs a weighted ranking algorithm that balances classification alignment and filter adherence. For each embedding in the match set, the system generates a relevance score based on its alignment with both the classification object and the filter object. The algorithm prioritizes embeddings that match both the classification intent and the filter criteria, ensuring that the top-ranked results are highly relevant to the user's specific query.

To maintain result diversity, especially for queries with multiple potential interpretations, the system may consider secondary classifications when the primary classification intent has been adequately addressed in the top results. This approach ensures that the final result set provides a comprehensive response to potentially multi-faceted or multi-classification queries.

The intelligent re-ranking system 147 may also incorporate functionality to generate confidence scores for each embedding in the match set, indicating the likelihood of its relevance to the query string. A dynamic threshold, adjusted based on the classification and filter objects, is applied to these confidence scores. Only embeddings exceeding this threshold are included in the final re-ranked match set, ensuring that all returned results meet a minimum relevance criteria. In one or more embodiments of the invention, to further enhance search results, the system may identify semantic relationships between embeddings in the match set and cluster semantically related embeddings. The ranking of embeddings within each cluster can be adjusted to ensure that the final result set represents a diverse range of relevant content, rather than multiple very similar results.

### Intelligent Re-Ranking with LLMS

In one or more embodiments of the invention, the intelligent re-ranking system 147 leverages the power of large language models to perform its sophisticated re-ranking and analysis tasks. LLMs are particularly well-suited for this role due to their ability to understand complex semantic relationships and context. In one or more embodiments, the system utilizes an LLM to process the re-ranking prompt. This prompt is constructed to provide the LLM with all relevant information about the query and the initial results. For example, a re-ranking prompt might be structured as follows:

“Given the search query ‘inspiring biopics about scientists’, represented by the query embedding [query_vector], and the following list of candidate results: [list_of_embedding_vectors], re-rank these results based on their relevance to the query. Consider that the query has been classified as ‘Biographical Films’ with a focus on ‘Science and Technology’. Additionally, the extracted filters indicate a preference for ‘inspiring’ content.”

In one or more embodiments of the invention, the LLM processes this prompt and analyzes each candidate result in the context of the query, its classification, and the extracted filters. It may consider factors such as the semantic similarity between the query and each result, the alignment of each result with the ‘Biographical Films’ and ‘Science and Technology’ classifications, and the likelihood that each result represents ‘inspiring’ content. The LLM's output is then used to reorder the results, potentially excluding some results that don't meet the relevance criteria and adjusting the ranking of others to better match the query intent.

In the case of outlier detection, a similar process is employed, but with a prompt specifically designed to identify results that may be semantically similar but contextually irrelevant. For instance:

“Analyze the following list of results [list_of_embedding_vectors] for the query ‘inspiring biopics about scientists’ [query_vector]. Identify any results that, while potentially related to science or biographies, do not specifically align with the concept of ‘inspiring biopics about scientists’. Assign an outlier score to each result, where a higher score indicates a greater likelihood of being an outlier.” The LLM's understanding of language and context allows it to identify subtle distinctions that might make a result less relevant, even if it shares some surface-level similarities with the query. By leveraging LLMs in this way, the intelligent re-ranking system 147 can perform highly nuanced and context-aware result ranking, significantly enhancing the relevance and quality of the final search results presented to the user.

In one or more embodiments of the invention, the intelligent re-ranking system 147 may generate a re-ranking prompt that includes the original query string, the classification object, the filter object, and metadata about the initial result set. This prompt can be used to execute the LLM, which evaluates the adherence of each result to the constraints specified in the filter object. The system may then generate a contextual importance score for each result based on this filter analysis. By combining the filter compliance score with the contextual importance score, the intelligent re-ranking system 147 creates a final re-ranking score for each result, which is used to re-order the result set.

In one or more embodiments of the invention, the intelligent re-ranking system 147 applies a threshold to the re-ranking scores to filter out results that fall below a certain relevance level, further refining the final result set presented to the user. This multi-step process potentially leads to more satisfactory search outcomes, as it combines the broad understanding of query intent with the fine-grained specificity of explicit filter criteria derived from the user's query.

In one or more embodiments of the invention, the augmented semantic search system incorporates user context and trending information to enhance the relevance and personalization of search results. The system may be configured to integrate user profiles and historical behavior data into its search and ranking process. When processing a query, the system considers factors such as the user's past searches, content preferences, viewing history, and explicit ratings or feedback. This contextual information is incorporated into the query embedding process, influencing both the initial retrieval of candidate results and the subsequent re-ranking phase. For instance, if a user has shown a preference for documentaries or foreign films, the system may subtly prioritize these types of content in the search results, even if not explicitly specified in the query.

Additionally, in one or more embodiments of the invention, the system is configured to take into account current trends and popular topics when ranking search results. This trending information is factored into the ranking algorithm, allowing the system to boost the relevance of results that align with current popular interests or topics. By integrating these elements of user context and trending topics, the system provides a search experience that is semantically accurate and personalized, while adapting to both individual user preferences and broader trends.

In one or more embodiments of the invention, the intelligent re-ranking system 147 employs a novel technique of enhanced retrieval augmented generation (RAG) to enhance its re-ranking capabilities. This approach may involve augmenting the prompt with explicit metadata and autodata for each of the related titles in the initial match set. By incorporating enhanced RAG, the system can leverage the rich, structured information available for each piece of content, including but not limited to genre classifications, character descriptions, plot summaries, and thematic elements. This additional context allows the large language model to make more informed decisions when re-ranking the results. For instance, when processing a query about “movies with complex anti-heroes,” the RAG-enhanced prompt might include character analysis data for each potential match, enabling the model to more accurately assess the relevance of each title.

### Applications

In one or more embodiments of the invention, the augmented semantic search system offers a wide range of applications and use cases, including content curation and extensibility to various domains. In the realm of content curation, the system's semantic understanding and classification capabilities enable it to intelligently organize and present media items based on complex criteria. For instance, the system can curate themed collections of movies or TV shows that share subtle thematic elements, stylistic features, or narrative structures that might not be captured by traditional keyword-based systems. This capability is particularly valuable for streaming platforms, media libraries, and educational resources, where it can enhance user engagement by surfacing relevant content that users might not have discovered through conventional search methods.

Furthermore, the system's architecture is highly extensible. The system can be adapted for use in diverse domains beyond video content. The core principles and algorithms can be applied to other content types such as books, music, podcasts, or even academic papers. For example, in a literary context, the system could analyze writing styles, themes, and character development to provide nuanced book recommendations. In music, it could identify songs with similar emotional resonance or compositional structures across different genres. This extensibility makes the system a versatile tool for any domain where semantic understanding and contextual relevance are crucial for effective content discovery and recommendation.

### Performance Tracking and Optimization

In one or more embodiments of the invention, the augmented semantic search system incorporates adaptive learning and model fine-tuning to continuously monitor and improve performance. This adaptive learning process begins with the analysis of user interactions, where the system meticulously tracks and examines how users engage with search results, including which results are clicked, how long users spend interacting with specific content, and any feedback provided. These interactions serve as valuable signals for understanding user preferences and the effectiveness of search results. The system leverages this data to generate labeled training examples, which are then used in a reinforcement learning framework to fine-tune the large language models (LLMs) employed in various stages of the search process. This fine-tuning allows the LLMs to adapt their ranking behavior based on evolving user preferences and emerging patterns in search behavior. The reinforcement learning approach rewards the model for actions that lead to positive user engagement and penalizes those that result in less satisfactory outcomes.

In one or more embodiments of the invention, the system incorporates periodic evaluation and performance tracking mechanisms. These evaluations assess the models across various domains and user segments, comparing their performance against baseline models and predefined benchmarks. This evaluation process helps identify areas for improvement. By implementing this comprehensive approach to adaptive learning and model fine-tuning, the augmented semantic search system maintains its relevance and effectiveness over time.

### Flowcharts

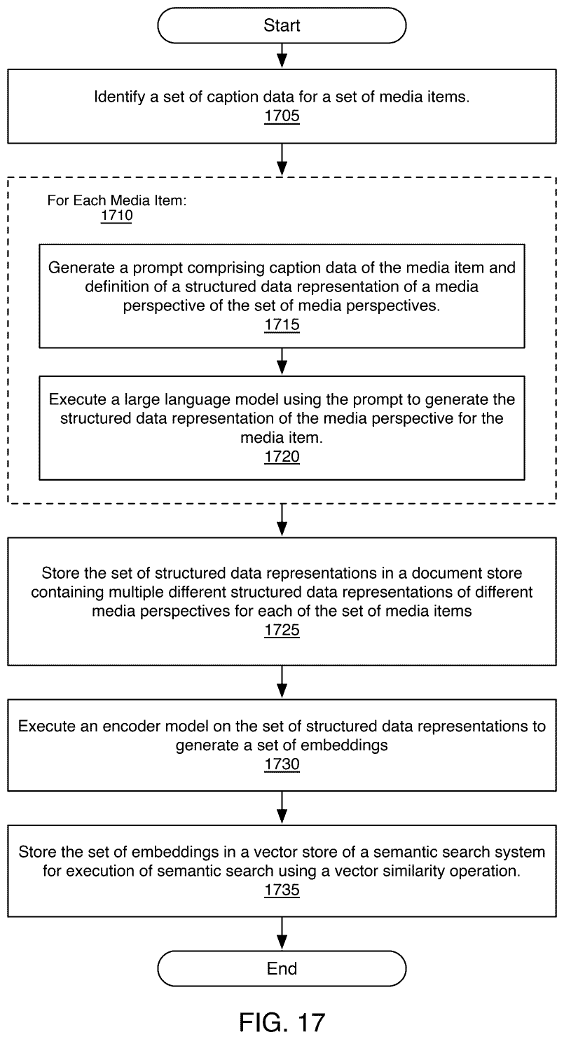

FIG. 17 shows a flowchart of a method for structured data representation of a set of media perspectives. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 17 should not be construed as limiting the scope of the invention.

In STEP 1705, a set of caption data for a set of media items is identified. This step may involve accessing various sources of media content, such as video platforms, streaming services, or databases, and extracting the associated caption data. The caption data may include subtitles, closed captions, or any textual representation of the audio content of the media items.

In STEP 1710, the method enters a loop to process each media item in the set. This step ensures that each media item is individually analyzed and processed to generate its structured data representation.

In STEP 1715, for each media item, a prompt is generated comprising the caption data of the media item and a definition of a structured data representation of a media perspective from the set of media perspectives. This prompt is designed to guide the large language model in generating the appropriate structured representation for the specific media item.

In STEP 1720, a large language model is executed using the prompt generated in the previous step. The model processes the caption data and the structural definition to generate the structured data representation of the media perspective for the current media item.

In STEP 1725, after processing all media items, the set of structured data representations is stored in a document store. This store contains multiple different structured data representations of different media perspectives for each of the set of media items, allowing for a rich and multifaceted representation of the media content.

In STEP 1730, an encoder model is executed on the set of structured data representations to generate a set of embeddings. This step transforms the structured textual data into dense vector representations that capture the semantic meaning of the media perspectives.

In STEP 1735, the set of embeddings generated in the previous step is stored in a vector store of a semantic search system. This vector store enables efficient execution of semantic search using vector similarity operations, allowing for rapid and accurate retrieval of relevant media items based on their semantic content.

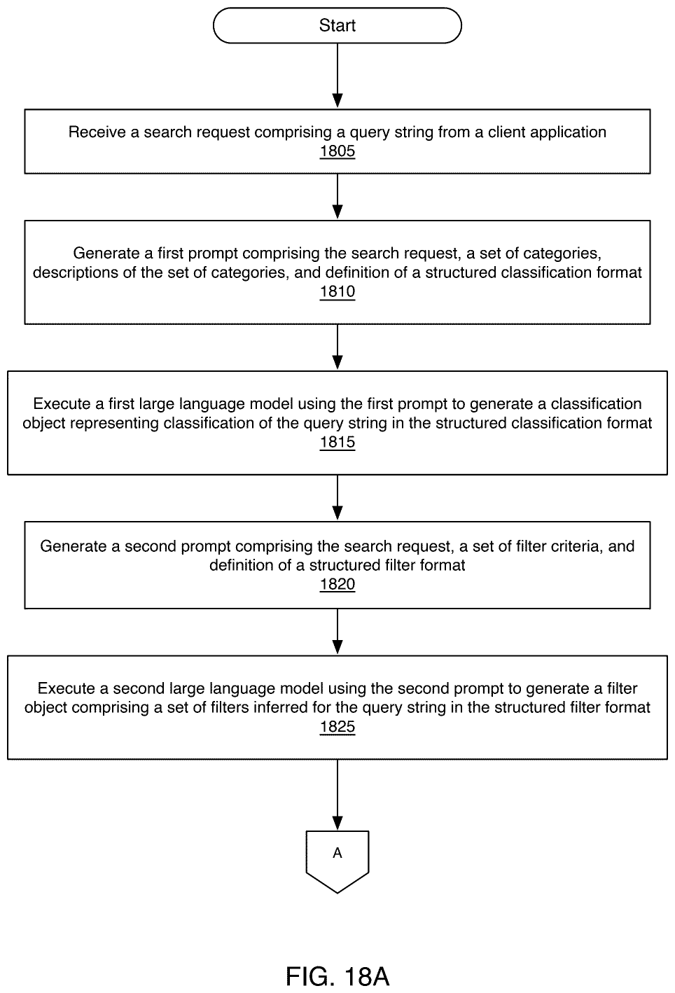

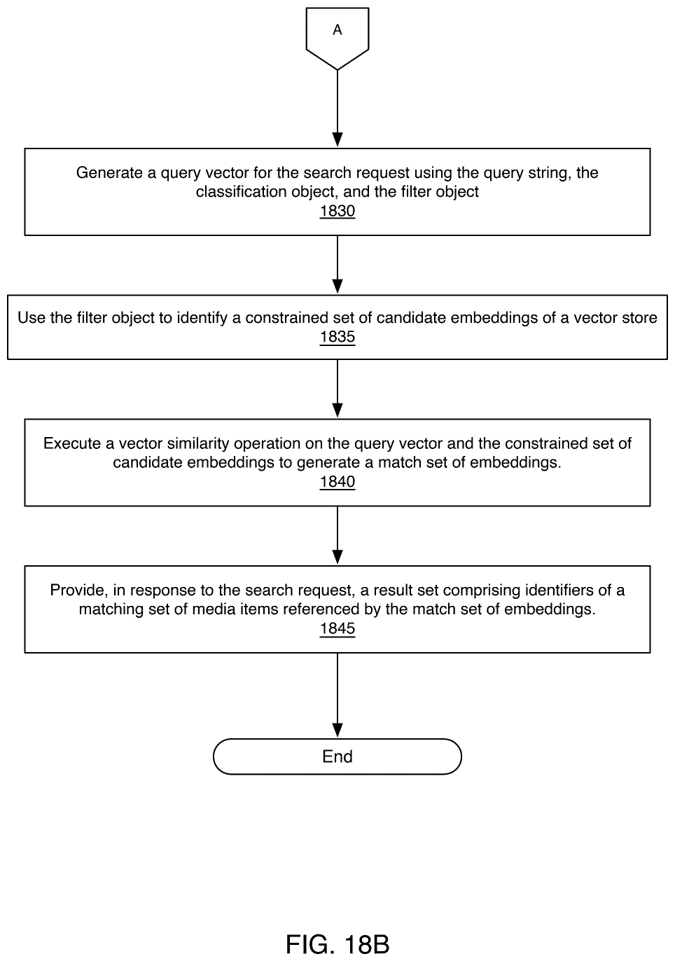

FIGS. 18A and 18B show flowcharts of a process for augmented semantic search. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIGS. 18A and 18B should not be construed as limiting the scope of the invention.

In STEP 1805, a search request comprising a query string is received from a client application. This step initiates the augmented semantic search process by accepting user input through an interface provided by the client application. The user input can be obtained from any client, including external applications via service-to-service communication, in accordance with various embodiments of the invention.

In STEP 1810, a prompt is generated comprising the search request, a set of categories, descriptions of the set of categories, and definition of a structured classification format. This prompt is designed to guide the subsequent classification process.

In STEP 1815, a first large language model is executed using the first prompt to generate a classification object representing classification of the query string in the structured classification format. This step leverages the power of large language models to understand and categorize the user's query.

In STEP 1820, a second prompt is generated comprising the search request, a set of filter criteria, and definition of a structured filter format. This prompt is created to facilitate the extraction of specific filters from the query.

In STEP 1825, a second large language model is executed using the second prompt to generate a filter object comprising a set of filters inferred for the query string in the structured filter format. This step identifies specific constraints or preferences expressed in the user's query.

In STEP 1830, a query vector for the search request is generated using the query string, the classification object, and the filter object. This step combines all the analyzed elements of the query into a single vector representation.

In STEP 1835, the filter object is used to identify a constrained set of candidate embeddings of a vector store. This step narrows down the search space based on the extracted filters.

In STEP 1840, a vector similarity operation is executed on the query vector and the constrained set of candidate embeddings to generate a match set of embeddings. This step identifies the most relevant results based on semantic similarity.

In STEP 1845, in response to the search request, a result set comprising identifiers of a matching set of media items referenced by the match set of embeddings is provided. This final step returns the search results to the user through the client application.

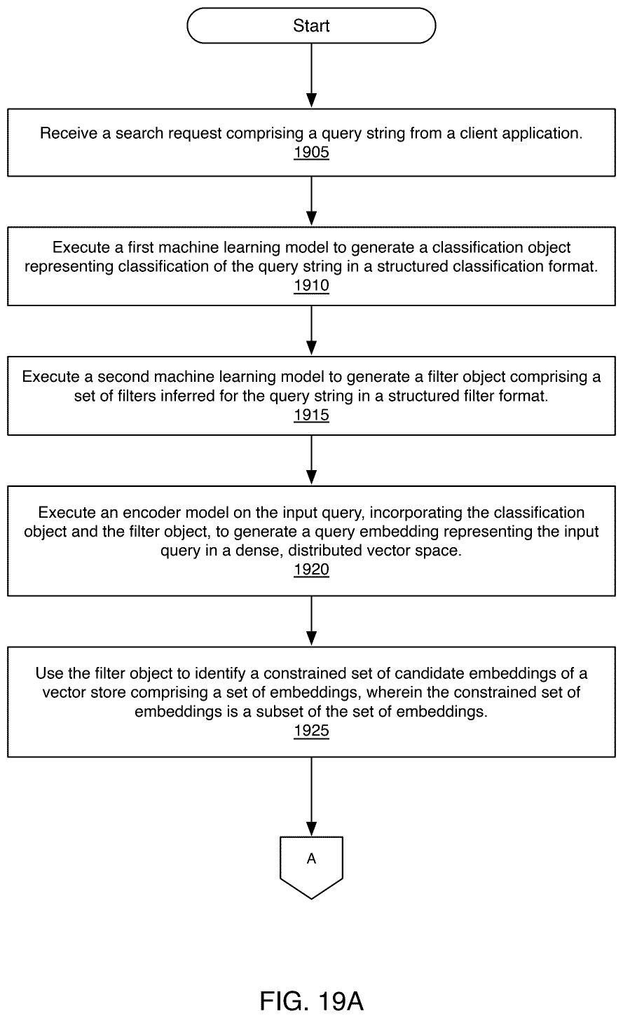

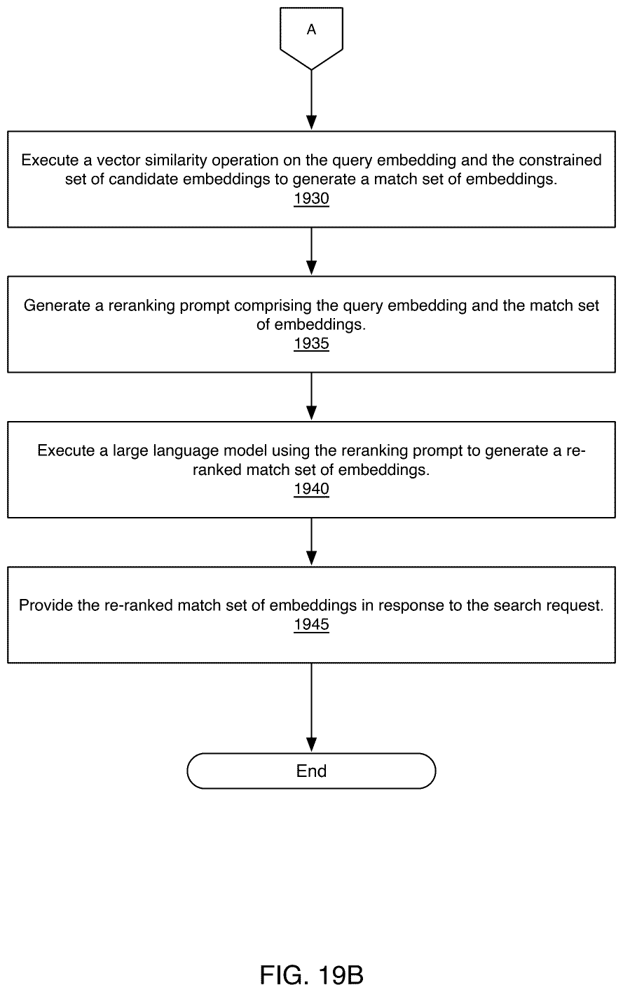

FIGS. 19A and 19B show flowcharts of a process for augmented semantic search. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIGS. 19A and 19B should not be construed as limiting the scope of the invention.

In STEP 1905, a search request comprising a query string is received from a client application. This step initiates the augmented semantic search process by accepting user input through an interface provided by the client application.

In STEP 1910, a first machine learning model is executed to generate a classification object representing classification of the query string in a structured classification format. This step leverages machine learning techniques to understand and categorize the user's query.

In STEP 1915, a second machine learning model is executed to generate a filter object comprising a set of filters inferred for the query string in a structured filter format. This step identifies specific constraints or preferences expressed in the user's query using machine learning algorithms.

In STEP 1920, an encoder model is executed on the input query, incorporating the classification object and the filter object, to generate a query embedding representing the input query in a dense, distributed vector space. This step combines all the analyzed elements of the query into a single vector representation.

In STEP 1925, the filter object is used to identify a constrained set of candidate embeddings of a vector store comprising a set of embeddings, wherein the constrained set of embeddings is a subset of the set of embeddings. This step narrows down the search space based on the extracted filters.

In STEP 1930, a vector similarity operation is executed on the query embedding and the constrained set of candidate embeddings to generate a match set of embeddings. This step identifies the most relevant results based on semantic similarity.

In STEP 1935, a re-ranking prompt is generated comprising the query embedding and the match set of embeddings. This prompt is created to guide the subsequent re-ranking process.

In STEP 1940, a large language model is executed using the re-ranking prompt to generate a re-ranked match set of embeddings. This step leverages the power of large language models to refine and optimize the search results.

In STEP 1945, the re-ranked match set of embeddings is provided in response to the search request. This final step returns the optimized search results to the user through the client application.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

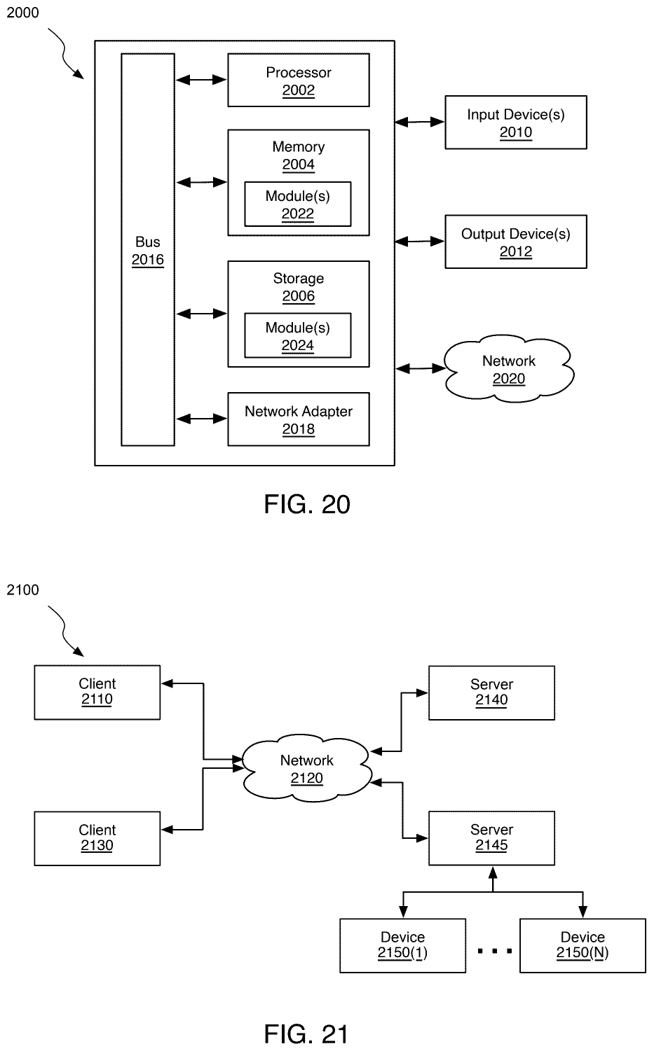

For example, as shown in FIG. 20, the computing system 2000 may include one or more computer processor(s) 2002, associated memory 2004 (e.g., random access memory (RAM), cache memory, flash memory, etc.), one or more storage device(s) 2006 (e.g., a hard disk, an optical drive such as a compact disk (CD) drive or digital versatile disk (DVD) drive, a flash memory stick, etc.), a bus 2016, and numerous other elements and functionalities. The computer processor(s) 2002 may be an integrated circuit for processing instructions. For example, the computer processor(s) may be one or more cores or micro-cores of a processor.

In one or more embodiments, the computer processor(s) 2002 may be an integrated circuit for processing instructions. For example, the computer processor(s) 2002 may be one or more cores or micro-cores of a processor. The computer processor(s) 2002 can implement/execute software modules stored by computing system 2000, such as module(s) 2022 stored in memory 2004 or module(s) 2024 stored in storage 2006. For example, one or more of the modules described herein can be stored in memory 2004 or storage 2006, where they can be accessed and processed by the computer processor 2002. In one or more embodiments, the computer processor(s) 2002 can be a special-purpose processor where software instructions are incorporated into the actual processor design.

The computing system 2000 may also include one or more input device(s) 2010, such as a touchscreen, keyboard, mouse, microphone, touchpad, electronic pen, or any other type of input device. Further, the computing system 2000 may include one or more output device(s) 2012, such as a screen (e.g., a liquid crystal display (LCD), a plasma display, touchscreen, or other display device), a printer, external storage, or any other output device. The computing system 2000 may be connected to a network 2020 (e.g., a local area network (LAN), a wide area network (WAN) such as the Internet, mobile network, or any other type of network) via a network interface connection 2018. The input and output device(s) may be locally or remotely connected (e.g., via the network 2020) to the computer processor(s) 2002, memory 2004, and storage device(s) 2006.

One or more elements of the aforementioned computing system 2000 may be located at a remote location and connected to the other elements over a network 2020. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

FIG. 21 is a block diagram of an example of a network architecture 2100 in which client systems 2110 and 2130, and servers 2140 and 2145, may be coupled to a network 2120. Network 2120 may be the same as or similar to network 2120. Client systems 2110 and 2130 generally represent any type or form of computing device or system, such as client devices (e.g., portable computers, smart phones, tablets, smart TVs, etc.).

Similarly, servers 2140 and 2145 generally represent computing devices or systems, such as application servers or database servers, configured to provide various database services and/or run certain software applications. Network 2120 generally represents any telecommunication or computer network including, for example, an intranet, a wide area network (WAN), a local area network (LAN), a personal area network (PAN), or the Internet.

With reference to computing system 2100 of FIG. 21, a communication interface, such as network adapter 2118, may be used to provide connectivity between each client system 2110 and 2130, and network 2120. Client systems 2110 and 2130 may be able to access information on server 2140 or 2145 using, for example, a Web browser, thin client application, or other client software. Such software may allow client systems 2110 and 2130 to access data hosted by server 2140, server 2145, or storage devices 2150(1)-(N). Although FIG. 21 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 2140, server 2145, storage devices 2150(1)-(N), or any combination thereof. All or a portion of one or more of the example embodiments disclosed herein may also be encoded as a computer program, stored in server 2140, run by server 2145, and distributed to client systems 2110 and 2130 over network 2120.

Although components of one or more systems disclosed herein may be depicted as being directly communicatively coupled to one another, this is not necessarily the case. For example, one or more of the components may be communicatively coupled via a distributed computing system, a cloud computing system, or a networked computer system communicating via the Internet.

And although only one computer system may be depicted herein, it should be appreciated that this one computer system may represent many computer systems, arranged in a central or distributed fashion. For example, such computer systems may be organized as a central cloud and/or may be distributed geographically or logically to edges of a system such as a content/data delivery network or other arrangement. It is understood that virtually any number of intermediary networking devices, such as switches, routers, servers, etc., may be used to facilitate communication.

One or more elements of the aforementioned computing system 2100 may be located at a remote location and connected to the other elements over a network 2120. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

One or more elements of the above-described systems (e.g., FIGS. 1A-1E) may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems (e.g., FIGS. 1A-1E) and/or flowcharts (e.g., FIGS. 17, 18A, 18B, 19A, and 19B). Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for augmented semantic search, comprising:
a computer processor;
a query execution service comprising functionality to:
receive a search request comprising a query string from a client application;
a query classification service comprising functionality to:
generate a first prompt comprising the search request, a set of categories, descriptions of the set of categories, and definition of a structured classification format; and
execute a first large language model using the first prompt to generate a classification object representing classification of the query string in the structured classification format;
a filter extraction service executing on the computer processor and comprising functionality to:
generate a second prompt comprising the search request, a set of filter criteria, and definition of a structured filter format; and
execute a second large language model using the second prompt to generate a filter object comprising a set of filters inferred for the query string in the structured filter format; and
a recaller service comprising functionality to:
generate a query vector for the search request using the query string, the classification object, and the filter object;
use the filter object to identify a constrained set of candidate embeddings of a vector store;
execute a vector similarity operation on the query vector and the constrained set of candidate embeddings to generate a match set of embeddings; and
provide, in response to the search request, a result set comprising identifiers of a matching set of media items referenced by the match set of embeddings.

2. The system of claim 1, further comprising:
an indexer service comprising functionality to:
obtain a set of structured data representations of media perspectives for a set of media items, wherein the set of structured data representations is generated based on caption data of the set of media items; and
execute an encoder model on the set of structured data representations to generate the set of embeddings stored in the vector store.

3. The system of claim 1, wherein the query classification service is further configured to:
analyze the query string to determine that it is associated with two or more disjoint classifications;
asynchronously analyze the query string for each classification using separate instances of the first large language model; and
merge the results using a multi-classification analyzer service to provide a comprehensive classification object.

4. The system of claim 3, wherein the multi-classification analyzer service is further configured to:
receive multiple classification objects comprising the classification object from separate instances of the first large language model;
analyze semantic relationships between the multiple classification objects;
generate a unified classification hierarchy that incorporates all identified classifications;
assign confidence scores to each classification within the unified hierarchy; and
produce a comprehensive classification object that comprises:
the unified classification hierarchy,
confidence scores for each classification,
potential conflicts or overlaps between classifications, and
a set of suggested query refinements based on the multiple classifications.

5. The system of claim 1, wherein each of the set of media items is associated with multiple different structured data representations of different media perspectives among the set of structured data representations, the different media perspectives comprising at least two selected from a group consisting of: hierarchical summaries, character and cast analyses, setting and time classifications, thematic and tonal analyses, plot and action detections, and micro-genre classifications.

6. The system of claim 1, wherein the classification object represents a classification of the entire query string, and the filter object comprises a set of filters inferred for specific entities or attributes within the query string.

7. The system of claim 1, further comprising an intelligent re-ranking system configured to:
generate a re-ranking prompt comprising the query string, the classification object, the filter object, and the match set of embeddings;
execute a third large language model using the re-ranking prompt to:
analyze the relevance of each embedding in the match set to the query intent derived from the classification object,
evaluate the adherence of each embedding to the constraints specified in the filter object, and
generate a contextual importance score for each embedding based on the classification and filter analysis;
re-rank the match set of embeddings based on the contextual importance scores; and
provide the re-ranked match set of embeddings in response to the search request.

8. The system of claim 1, wherein the filter extraction service is further configured to:
identify named entities in the query string;
map the named entities to predefined filter criteria; and
include entity-specific filter parameters in the filter object.

9. The system of claim 1, further comprising a data validation and quality control module configured to:
analyze the classification object and filter object for consistency with historical search patterns; and
adjust the classification object or filter object if inconsistencies are detected, thereby improving the accuracy of query vector generation.

10. A method for augmented semantic search, comprising:
receiving a search request comprising a query string from a client application;
generating a first prompt comprising the search request, a set of categories, descriptions of the set of categories, and definition of a structured classification format;
executing, by a computer processor, a first large language model using the first prompt to generate a classification object representing classification of the query string in the structured classification format;
generating a second prompt comprising the search request, a set of filter criteria, and definition of a structured filter format;
executing a second large language model using the second prompt to generate a filter object comprising a set of filters inferred for the query string in the structured filter format;
generating a query vector for the search request using the query string, the classification object, and the filter object;
using the filter object to identify a constrained set of candidate embeddings of a vector store;
executing a vector similarity operation on the query vector and the constrained set of candidate embeddings to generate a match set of embeddings; and
providing, in response to the search request, a result set comprising identifiers of a matching set of media items referenced by the match set of embeddings.

11. The method of claim 10, further comprising:
obtaining a set of structured data representations of media perspectives for a set of media items, wherein the set of structured data representations is generated based on caption data of the set of media items; and
executing an encoder model on the set of structured data representations to generate the set of embeddings stored in the vector store.

12. The method of claim 10, further comprising:
analyzing the query string to determine that it is associated with two or more disjoint classifications;
asynchronously analyzing the query string for each classification using separate instances of the first large language model; and
merging the results using a multi-classification analyzer service to provide a comprehensive classification object.

13. The method of claim 12, further comprising:
receiving multiple classification objects comprising the classification object from separate instances of the first large language model;
analyzing semantic relationships between the multiple classification objects;
generating a unified classification hierarchy that incorporates all identified classifications;
assigning confidence scores to each classification within the unified hierarchy; and
producing a comprehensive classification object that comprises:
the unified classification hierarchy,
confidence scores for each classification,
potential conflicts or overlaps between classifications, and
a set of suggested query refinements based on the multiple classifications.

14. The method of claim 10, wherein each of the set of media items is associated with multiple different structured data representations of different media perspectives among the set of structured data representations, the different media perspectives comprising at least two selected from a group consisting of: hierarchical summaries, character and cast analyses, setting and time classifications, thematic and tonal analyses, plot and action detections, and micro-genre classifications.

15. The method of claim 10, wherein the classification object represents a classification of the entire query string, and the filter object comprises a set of filters inferred for specific entities or attributes within the query string.

16. The method of claim 10, further comprising:
generating a re-ranking prompt comprising the query string, the classification object, the filter object, and the match set of embeddings;
executing a third large language model using the re-ranking prompt to:
analyze the relevance of each embedding in the match set to the query intent derived from the classification object,
evaluate the adherence of each embedding to the constraints specified in the filter object, and
generate a contextual importance score for each embedding based on the classification and filter analysis;
re-ranking the match set of embeddings based on the contextual importance scores; and
providing the re-ranked match set of embeddings in response to the search request.

17. The method of claim 10, further comprising:
identifying named entities in the query string;
mapping the named entities to predefined filter criteria; and
including entity-specific filter parameters in the filter object.

18. The method of claim 10, further comprising:
analyzing the classification object and filter object for consistency with historical search patterns; and
adjusting the classification object or filter object if inconsistencies are detected, thereby improving the accuracy of query vector generation.

19. A non-transitory computer-readable storage medium comprising a plurality of instructions for augmented semantic search, the plurality of instructions configured to execute on at least one computer processor to enable the at least one computer processor to:
receive a search request comprising a query string from a client application;
generate a first prompt comprising the search request, a set of categories, descriptions of the set of categories, and definition of a structured classification format;
execute a first large language model using the first prompt to generate a classification object representing classification of the query string in the structured classification format;
generate a second prompt comprising the search request, a set of filter criteria, and definition of a structured filter format;
execute a second large language model using the second prompt to generate a filter object comprising a set of filters inferred for the query string in the structured filter format;
generate a query vector for the search request using the query string, the classification object, and the filter object;
use the filter object to identify a constrained set of candidate embeddings of a vector store;
execute a vector similarity operation on the query vector and the constrained set of candidate embeddings to generate a match set of embeddings; and
provide, in response to the search request, a result set comprising identifiers of a matching set of media items referenced by the match set of embeddings.

20. The non-transitory computer-readable storage medium of claim 19, the plurality of instructions further configured to enable the at least one computer processor to:
analyze the query string to determine that it is associated with two or more disjoint classifications;
asynchronously analyze the query string for each classification using separate instances of the first large language model; and
merge the results using a multi-classification analyzer service to provide a comprehensive classification object.
